(19) United States
(12) Patent Application Publication
(10) Pub. No.: US 2026/0183674 A1
(43) Pub. Date: Jul. 2, 2026

(54) PROGRAM, EFFECT CHANGE METHOD, AND GAME APPARATUS

(71) Applicant: CYGAMES, INC., Tokyo (JP)

(72) Inventors: Masaya Kimoto, Tokyo (JP); Wataru Nishimine, Tokyo (JP); Kyohei Murakami, Tokyo (JP); Yasuhiro Arai, Tokyo (JP); Yasuyuki Kaji, Tokyo (JP)

(73) Assignee: CYGAMES, INC., Tokyo (JP)

(21) Appl. No.: 19/540,231

(22) Filed: Feb. 13, 2026

Related U.S. Application Data
(63) Continuation of application No. PCT/JP2024/033640, filed on Sep. 20, 2024.

(30) Foreign Application Priority Data
Sep. 22, 2023 (JP) 2023-158100

(51) Int. Cl. A63F 13/69; A63F 13/533; A63F 13/58

(52) U.S. Cl. CPC A63F 13/69; A63F 13/533; A63F 13/58

(57) ABSTRACT

A game apparatus includes a game content effect change unit configured to change a game content effect of game content by satisfying a change factor unlocking condition, and a game element effect change unit configured to change a game element effect of a game element by satisfying a game element unlocking condition determined for each of a plurality of the game elements associated with the individual piece of game content. The game content effect change unit changes the game content effect by satisfying the change factor unlocking condition associated with a specific change factor after the game element effect of the game element associated with the specific change factor in which the game content effect is changed by the change of the game element effect reaches a specified value.

### TECHNICAL FIELD

The present invention relates to a program, an effect change method, and a game apparatus.

### BACKGROUND ART

In an existing game in which a character can be grown, a skill tree is provided that enables a player of the game to select any skill and thus causes the character to acquire the skill.

The skill tree is constituted by a plurality of nodes, and various skills that can be acquired by the character are associated with the nodes. The player can unlock the node and cause the character to acquire the skill associated with the node by consuming a certain number of points for growth or material items acquired by the character, for example. Until now, various games have been provided in which the skill of a character can be changed using a skill tree.

For example, Patent Literature 1 describes a skill tree including a plurality of nodes displayed in a display region.

Citation List

Patent Literature

Patent Literature 1: JP 6943474 A

### SUMMARY OF INVENTION

### Technical Problem

Game developers provide games including a variety of items and events to encourage players to enjoy the games over an extended period of time. In such a game, different effects can be given to a character or various types of performance can be displayed corresponding to the types of items acquired by the character.

In an existing game, a skill tree for the purpose of growing a character is provided. On the other hand, since game elements (a weapon, protective equipment, and the like) that are used by a character are often strengthened by consuming a specific material or the like, no skill tree has been used for strengthening the game elements. Thus, when a certain game element is sufficiently strengthened, the game can be advanced only using the strengthened game element. This makes it difficult to maintain the motivation of the player to cause the character to use another game element that is not strengthened.

In addition, since the player cannot enjoy the performance using another element that is not strengthened, the progress of the game tends to be monotonous.

The present invention has been made in view of such a situation, and an object of the present invention is to keep a player motivated to use various game elements.

### Solution to Problem

According to the present invention, there is provided a program for providing a game in which a change factor unlocking condition is determined for an individual change factor and a change element including a plurality of the change factors is provided for an individual piece of game content, the program being configured to cause a computer to execute: changing a game content effect of the individual piece of game content by satisfying the change factor unlocking condition; changing a game element effect of a game element by satisfying a game element unlocking condition determined for each of a plurality of the game elements associated with the individual piece of game content; and changing the game content effect by satisfying the change factor unlocking condition associated with a specific change factor after the game element effect of the game element associated with the specific change factor in which the game content effect is changed by the change of the game element effect reaches a specified value.

### Advantageous Effects of Invention

According to the present invention, after the game element effect of the game element reaches the specified value, the game content effect is changed by satisfying the change factor unlocking condition associated with the specific change factor, and thus it is expected that the player can maintain motivation to use various game elements.

Problems, configurations, and effects other than those described above will become apparent from the following description of embodiments.

### BRIEF DESCRIPTION OF DRAWINGS

FIG. 1 is an overall configuration diagram illustrating an outline of a game system according to a first embodiment of the present invention.

FIG. 2 is a block diagram illustrating a hardware configuration example of the game system according to the first embodiment of the present invention.

FIG. 3 is a block diagram illustrating a functional configuration example of the game system according to the first embodiment of the present invention.

FIG. 4 is a diagram illustrating an external configuration example of a controller according to the first embodiment of the present invention.

FIG. 5 is a diagram illustrating a configuration example of a skill tree according to the first embodiment of the present invention.

FIG. 6 is a diagram illustrating a configuration example of a node management table and a restriction lifting condition management table according to the first embodiment of the present invention.

FIG. 7 is a diagram illustrating a configuration example of a weapon enhancement management table and a weapon level limit management table according to the first embodiment of the present invention.

FIG. 8 is a diagram illustrating a display example of a skill setting screen according to the first embodiment of the present invention.

FIG. 9 is a diagram illustrating a display example of a skill acquisition sub-screen according to the first embodiment of the present invention.

FIG. 10 is a diagram illustrating a display example of a multi-skill acquisition sub-screen according to the first embodiment of the present invention.

FIG. 11 is a diagram illustrating a display example of a weapon enhancement screen according to the first embodiment of the present invention.

FIG. 12 is a diagram illustrating a display example of a weapon enhancement sub-screen and a limit break sub-screen according to the first embodiment of the present invention.

FIG. 13 is a flowchart illustrating an example of processing for selecting a locked node according to the first embodiment of the present invention.

FIG. 14 is a flowchart illustrating an example of processing for unlocking a node according to the first embodiment of the present invention.

FIG. 15 is a flowchart illustrating an example of processing for weapon enhancement according to the first embodiment of the present invention.

FIG. 16 is a diagram illustrating a configuration example of a skill tree according to a modified example of the first embodiment of the present invention.

FIG. 17 is a diagram illustrating a display example of a skill setting screen according to a second embodiment of the present invention.

FIG. 18 is a diagram illustrating a display example of a weapon enhancement bonus screen according to the second embodiment of the present invention.

FIG. 19 is a flowchart illustrating an example of processing for a weapon enhancement bonus according to the second embodiment of the present invention.

### DESCRIPTION OF EMBODIMENTS

An embodiment for carrying out the present invention will be described below with reference to the attached drawings. In the present description and the drawings, elements having substantially the same function or configuration are denoted by the same reference signs and numerals, and redundant description thereof will be omitted.

### Definitions of Terms

First, definitions of terms used in common in the present description will be described. The terms, which will be described below, are used in a game to which the present invention is applied.

### Game

To begin with, a game will be described.

The game is a form of play in which a predetermined effect can be obtained by executing a program of the game by various information processing terminals. The game includes at least one selected from the group consisting of moving image data, image data, sound data, book data, and text data, and is expressed by combining a plurality of pieces of data as appropriate. Normally, the game can be progressed by a player who is a natural person performing various operations. Alternatively, the game can be automatically progressed by the player giving a predetermined command.

### Game Content

In the game, identifications (IDs) are assigned to various elements. The elements to which the IDs are assigned and that are managed by the IDs are referred to as “game content”. The game content is often used in internal processing of the game. Thus, the presence or absence of display of the game content on a screen is not essential, unlike an object displayed on the screen.

For example, as the game content, characters in the game, items (equipped items, consumption items, costumes of the characters, or the like), cards, elements that are drawn in a random drawing game, or the like are assumed. In addition, as the game content, items each of which includes one or more of the following usages or actions are assumed. Examples of the items include an item that changes (strengthens or weakens) another piece of game content, an item that changes (strengthens or weakens) a certain parameter, an item that can cause a return to be obtained by consuming the game content, and an item that is a target of organization by a player and exhibits an effect in the game.

### Object

In the game, a screen is displayed on a display device of a terminal on which a player plays the game. On the screen, various computer graphic images (hereinafter simply referred to as the “image”) are displayed as objects. Here, objects are generally divided into two-dimensional images and three-dimensional images. The object of the two-dimensional image is an image configured by two-dimensional computer graphics, and examples thereof include illustration images (characters, items, or the like) of game content, or images (buttons, a virtual pad, or the like) of a user interface. Similarly, the object of the three-dimensional image is an image configured by three-dimensional computer graphics, and examples thereof include characters, items, and a background.

### Attribute

An attribute is data used to classify the game content, and is a part of data commonly given to a plurality of pieces of game content or a plurality of objects. For example, the attribute is data for distinguishing a certain character or data for determining a degree of rarity of a certain item. The attribute is often displayed on the screen when the game is played. Note that the attribute may be used only in an internal process of the program, and is not displayed on the screen in some cases.

### Currency

In the game, currency for exchange with an item and the like is used. This currency includes paid currency that is valuable in the real world and parameters that are used only in the game. Examples of the paid currency include cash, electronic money, and in-game currency purchased with real money. Examples of the parameter that is used only in the game include in-game currency provided free of charge in the game.

Furthermore, examples of the in-game currency also include free currency that is consumed in random draw processing, which will be described below. Note that points and the like that are used in the game may be used in the same meaning as currency.

### Reward

The player can obtain a reward by playing the game. Rewards are generally classified into a reward that is given to a player ID assigned to identify a player and a reward that is not given to the player ID. Examples of the reward that is given to the player ID include items, and the rewards such as the items are used for varying a predetermined parameter (an experience value, stamina, a right of random draw, or the like) or for progressing the game. Further, it is assumed that the reward allows, for example, unlock of a quest that can be played, acquisition of a skill or an ability of the character, browsing of a music video, and the like. Examples of the reward that is not given to the player ID include display of a reward image or a reward moving image, occurrence of an event specific to the game, and the like.

### Random Draw Processing

In the game, random draw processing for giving a privilege to the player may be performed. The random draw processing is processing for stochastically determining a result by using a software random number generated in the game. Regarding software random numbers, when the seed value is the same, the same values are generated. In the random draw processing, the result may be determined by using a pseudo-random number sequence generated in advance instead of the software random numbers. The random draw processing is generally divided into processing of consuming a predetermined cost and determining a reward by the random draw processing (processing by a so-called gacha) and the other processing.

The processing of consuming a predetermined cost and determining a reward by random draw processing includes a non-replacement draw (processing in which the random draw probability is constant or processing in which the random draw probability varies) and a replacement draw (processing in which the number of items or the like is announced and a target item is obtained by increasing the number of random draws). The other processing includes random draw processing of a game reward, matching processing in the game in which characters are caused to battle with each other, calculation processing of damage when an attack is given, action determination processing of a non-player character (NPC), who is a character that is not operated by the player, and the like.

### Game Effect

The game has an effect (referred to as a “game effect”) associated with the game content, the object, or the like. Examples of the game effect include a skill, an ability, a special ability, and the like of the character. The game effect has some influence on the progress of the game, and is defined by a combination freely selected from among an activation condition for activating the game effect, an application target of the game effect, and an effect amount of the game effect.

### First Embodiment

### Overall Configuration Example of Game System

First, a configuration example of a game system according to a first embodiment of the present invention will be described. This game system is configured by combining a game server that distributes a game and an information processing terminal. The game distributed by the game server includes a program and data related to the game.

### Outline of Game System

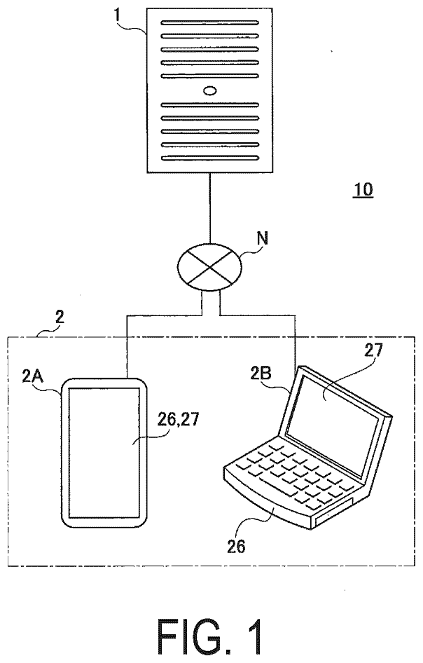

FIG. 1 is an overall configuration diagram illustrating an outline of a game system 10 according to the first embodiment.

The game system 10 includes a game server 1, a smartphone 2A, and a personal computer (PC) 2B. The smartphone 2A and the PC 2B can be connected to the game server 1 via a network N such as the Internet. In the following description, the smartphone 2A and the PC 2B are collectively referred to as the information processing terminal 2. As the information processing terminal 2, for example, a dedicated game terminal may be used.

The game server 1 is an example of a first information processing apparatus constituting the game system 10. The game server 1 manages the program and data of the game, and distributes the program and data of the game to the information processing terminal 2 based on a data acquisition request from the authenticated information processing terminal 2.

The information processing terminal 2 processes the program and data of the game received from the game server 1. Additionally, the program according to the present embodiment controls the display form of text, images, and the like displayed on an output device 27 (an example of a display unit) according to the progress of the game, in accordance with a command input via an input device 26 (an example of an input unit).

In the smartphone 2A, a touch panel display device in which the input device 26 and the output device 27 are integrated is used. The smartphone 2A may be a tablet terminal.

Further, in the PC 2B, the input device 26 and the output device 27 are separately provided. Note that the PC 2B may be a desktop PC, and the input device 26 and the output device 27 may be separately provided and connected to the desktop PC.

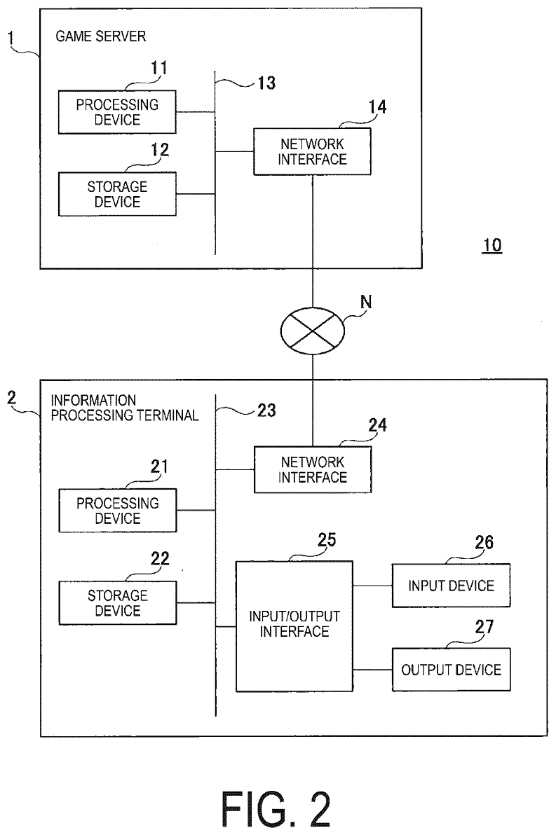

The information processing terminal 2 is an example of a second information processing apparatus constituting the game system 10. The information processing terminal 2 can store data including a program that is a source of the game downloaded from the game server 1 in a storage device 22 illustrated in FIG. 2, which will be described below.

Note that the information processing terminal 2 can also read out data including a program that is a source of the game from a memory, an optical disk, or the like. Then, the information processing terminal 2 executes the program read from the storage device 22, thereby expressing the game. In addition, when a processing result of a game processed by the game server 1 is distributed to the information processing terminal 2, the information processing terminal 2 can display the processing result using an Internet browser, or a player can progress the game, for example.

The information processing terminal 2 selects a program based on an operation signal input from the input device 26 by an operation performed by the player, and outputs a video signal corresponding to a screen of the output device 27 to the output device 27. The output device 27 displays a video, based on the video signal. The operation signal input from the input device 26 is, for example, a signal corresponding to each operation stick and operation button of a controller. The player can input a command and operate the character through the input device 26.

The information processing terminal 2 stores the data of the game downloaded from the game server 1 in the storage device 22 illustrated in FIG. 2, which will be described below. In addition, the information processing terminal 2 performs processing of reading out the data of the game from the storage device 22 and executing the program, processing of drawing the screen in accordance with the operation signal input from the input device 26, processing of displaying the screen by the output device 27, and the like.

For example, the information processing terminal 2 displays, on the output device 27, the screen on which various scenes including the character are drawn according to an operation performed by the player through the input device 26.

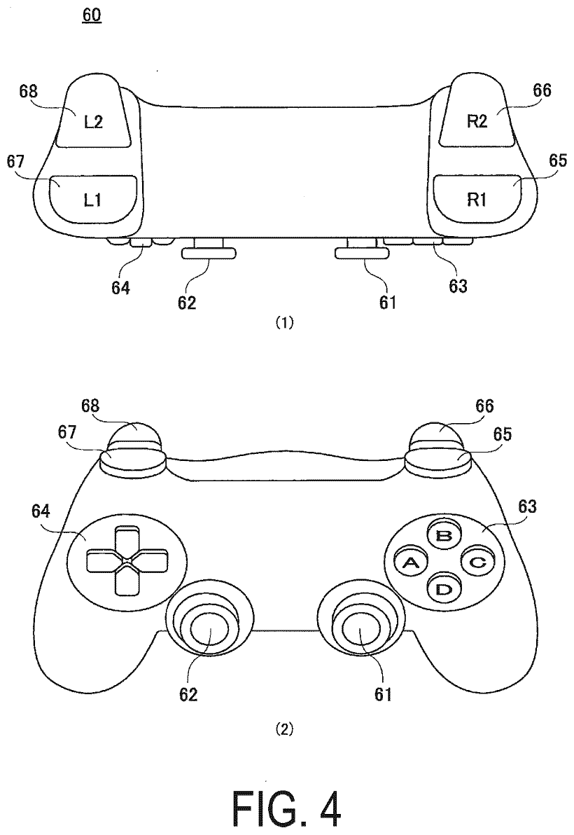

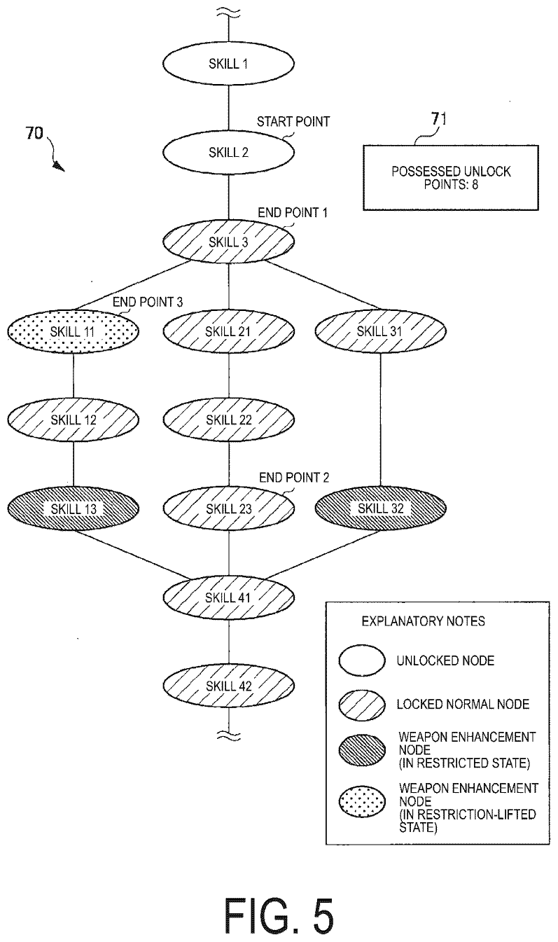

Examples of the operation on the character input from the input device 26 include various types of command inputs such as a response to a conversation made by the character, an instruction to the character, selection of a weapon, protective equipment, or the like that is used or equipped by the character, level-up of the character, and selection of a node included in a skill tree 70 (see FIG. 5, which will be described below). In the present embodiment, among the items, a weapon equipped by the character will be described. In the present embodiment, an operation of buttons, a stick, or the like of a controller 60 (see FIG. 4, which will be described below) connected to the information processing terminal 2 is assumed as an example of the operation performed from the input device 26. Note that a tap operation of touching the screen of the output device 27 with a finger or a pen is also included as an example. The character and the scene displayed on the output device 27 are changed by the operation performed using the input device 26.

### Hardware Configuration Example of Game System

Next, a hardware configuration example of the game system 10 according to the first embodiment will be described.

FIG. 2 is a block diagram illustrating the hardware configuration example of the game system 10.

### Configuration Example of Game Server

The game server 1 is an example of a computing machine that operates as a computer capable of executing various programs. The game server 1 includes a processing device 11, a storage device 12, and a network interface 14, which are connected to a bus 13.

The processing device 11 is configured by, for example, at least one selected from the group consisting of a central processing unit (CPU), a microprocessor unit (MPU), a graphics processing unit (GPU), and a field programmable gate array (FPGA). The processing device 11 reads out program codes of software for implementing each function according to the present embodiment from the storage device 12, loads the program codes into a temporary storage unit provided in the storage device 12 (not illustrated), and executes the program codes. The processing device 11 performs, for example, arithmetic processing of the game, and processing necessary for drawing an object on the screen of the information processing terminal 2.

The storage device 12 is configured by a read only memory (ROM) and a random access memory (RAM). As the ROM, an optical disk, a magneto-optical disk, a digital versatile disc (DVD)-ROM, a CD-ROM, a Blu-ray (trade name) disc, or the like is used. As the RAM, a static random access memory (SRAM), a dynamic random access memory (DRAM), or the like is used. Variables, parameters, and the like generated during arithmetic processing of the processing device 11 are temporarily written in the storage device 12, and these variables, parameters, and the like are appropriately read out by the processing device 11.

In addition, the storage device 12 is configured by, for example, at least one selected from the group consisting of a hard disk drive (HDD), a solid state drive (SSD), and a flash memory. The storage device 12 stores an operating system (OS) of the game server 1, various parameters, and a program for causing the game server 1 to function. The storage device 12 stores a program, data, and the like necessary for the processing device 11 to operate, as described above, and is used as an example of a non-transitory computer-readable storage medium storing a program to be executed by the game server 1.

For example, a network interface card (NIC) or the like is used as the network interface 14. The network interface 14 can transmit and receive various types of data to and from the information processing terminal 2 via the network N through a dedicated line, or the like connected to a terminal of the NIC.

### Configuration Example of Information Processing Terminal

The information processing terminal 2 is an example of a computing machine that operates as a computer capable of executing various programs. The information processing terminal 2 includes a processing device 21, a storage device 22, a network interface 24 and an input/output interface 25, which are connected to a bus 23. The input device 26 and the output device 27 included in the information processing terminal 2 are connected to the bus 23 via the input/output interface 25.

The processing device 21 is configured by at least one selected from the group consisting of a CPU, an MPU, a GPU, and an FPGA, for example. The processing device 21 reads out program codes of software for implementing each function according to the present embodiment from the storage device 22, loads the program codes into a temporary storage unit (not illustrated) provided in the storage device 22, and executes the program codes. The processing device 21 performs, for example, arithmetic processing of the game, and processing necessary for drawing an object on the screen of the information processing terminal 2. Further, the processing device 21 performs processing of an operating system (OS) of the information processing terminal 2 and processing such as management of data input/output to be performed by each unit in the information processing terminal 2. In addition, when the processing device 21 handles information related to the game, the processing device 21 can also output a sound signal, an operation signal of an actuator, and the like to the output device 27 through the input/output interface 25 in addition to the image signal.

The storage device 22 is configured by, for example, a ROM and a RAM. As the ROM, an optical disk, a magneto-optical disk, a DVD-ROM, a CD-ROM, a Blu-ray (trade name) disc, or the like is used. As the RAM, an SRAM, a DRAM, or the like is used. Variables, parameters, and the like generated during arithmetic processing of the processing device 21 are temporarily written in the storage device 22, and these variables, parameters, and the like are appropriately read out by the processing device 21. The processing device 21 also performs processing necessary for drawing a two-dimensional object or a three-dimensional object constituting a character or a background on the screen of the output device 27, for example.

Additionally, the storage device 22 is configured by, for example, at least one selected from the group consisting of an HDD, an SSD, and a flash memory. The storage device 22 stores a program for causing the information processing terminal 2 to function, the program of the game, and the like, in addition to an OS of the information processing terminal 2 and various parameters. The storage device 22 stores the programs, the data, and the like necessary for the processing device 21 to operate, as described above, and is used as an example of a non-transitory computer-readable storage medium storing the program to be executed by the information processing terminal 2.

For example, a network interface card (NIC) or the like is used as the network interface 24. The network interface 24 can transmit and receive various types of data to and from the game server 1 via the network N through a dedicated line connected to a terminal of the NIC, and can communicate with another information processing terminal 2.

The input/output interface 25 converts an operation signal received from the input device 26 into data in a predetermined format and transfers the converted data to the processing device 21. The input/output interface 25 also converts screen data drawn by the processing device 21 into a video signal and outputs the video signal to the output device 27.

The input device 26 is a device that receives an input command from the player or various types of information. Examples of the input device 26 include a pointing device that can input coordinate information of a position designated by the player. The pointing device may be a mouse, a touch panel device, or the like. The touch panel device is configured by combining the input device 26 and the output device 27. The input device 26 may be a game controller (a controller 60 illustrated in FIG. 4, which will be described below), a keyboard, a microphone, a global positioning system (GPS) device, or various sensors. As the various sensors, for example, an acceleration sensor (a six-axis sensor, a gyroscope, or the like), an optical sensor (a camera or the like), a pressure sensor (a pressure-sensitive touch sensor or the like), a barometric pressure sensor, and the like are assumed.

The output device 27 is a device that outputs information processed by the processing device 21. Examples of the output device 27 include a display device (a display device, a touch panel device, or the like), an acoustic device (a speaker, a headphone, or the like), and an actuator (a vibration device, tactile feedback, or the like). When the output device 27 is used as the display device, the display device displays a video based on the video signal received from the input/output interface 25. When the output device 27 is an acoustic device, sounds such as background music (BGM), sound effects, and character voices are emitted. When the output device 27 is an actuator, the output device 27 vibrates or provides tactile feedback according to a scene of the game.

### Functional Configuration Example of Game System

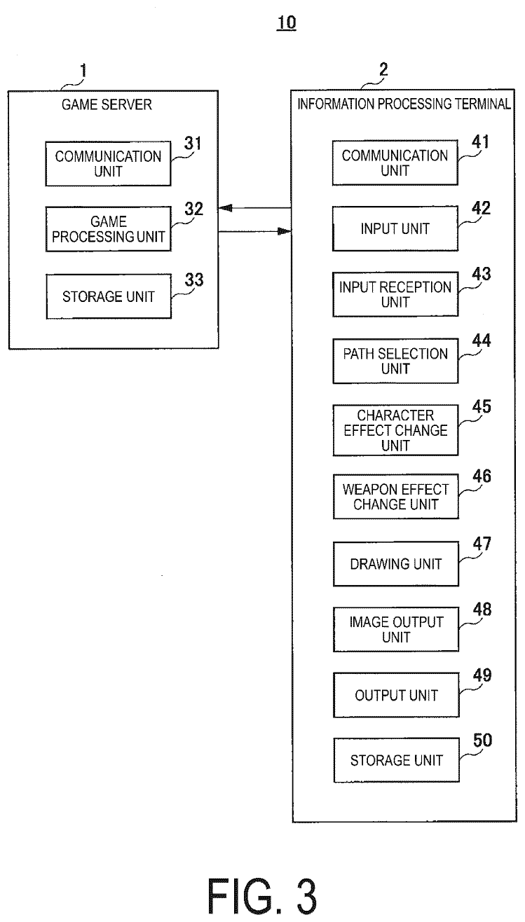

Next, a functional configuration example of the game system 10 will be described with reference to FIG. 3.

FIG. 3 is a block diagram illustrating a functional configuration example of the game system 10. In FIG. 3, the communication network N is not illustrated.

### Functional Configuration Example of Game Server

The game server 1 includes a communication unit 31, a game processing unit 32, and a storage unit 33.

The communication unit 31 controls communication with the information processing terminal 2. For example, when the communication unit 31 receives a data acquisition request or the like transmitted from the information processing terminal 2, the communication unit 31 outputs the data acquisition request to the game processing unit 32, and transmits data of the game processed by the game processing unit 32 to the information processing terminal 2. The functions of the communication unit 31 are implemented by the processing device 11, the network interface 14, and the like illustrated in FIG. 2.

The game processing unit 32 selects and reads out data for the game to be used in the information processing terminal 2 from the storage unit 33 based on the data acquisition request input from the communication unit 31. Then, the game processing unit 32 outputs the read-out data for the game to the communication unit 31. Note that the game processing unit 32 may perform processing based on the read-out data for the game and then output data of the processing result to the communication unit 31. The function of the game processing unit 32 is implemented by the processing device 11 and the storage device 12 illustrated in FIG. 2.

The storage unit 33 stores the data for the game. The function of the storage unit 33 is implemented by the storage device 12 illustrated in FIG. 2. The storage unit 33 also stores data of the player who plays the game. The data of the player is used for authentication processing of the player, and the like.

Functional Configuration Example of Information Processing Terminal

The information processing terminal 2 includes a communication unit 41, an input unit 42, an input reception unit 43, a path selection unit 44, a character effect change unit 45, a weapon effect change unit 46, a drawing unit 47, an image output unit 48, an output unit 49, and a storage unit 50.

The communication unit 41 transmits, to the game server 1, information related to data or the like requested to be acquired by the game to be played by the player as the data acquisition request. Then, the communication unit 41 writes the data of the game delivered from the game server 1 into the storage unit 50. The function of the communication unit 41 is implemented by the processing device 21 and the network interface 24 illustrated in FIG. 2.

The input unit 42 outputs an operation signal generated based on an operation input by the player to the input reception unit 43. The operation input by the player is assumed to be an operation by using various buttons, a stick, and the like of the controller 60 (see FIG. 4, which will be described below) used as an example of the input device 26. In the present embodiment, the operations input by the player include, for example, an operation in which the player selects one or more nodes from the skill tree 70 illustrated in FIG. 5, which will be described below, an operation of selecting a screen on which the skill tree 70 is displayed, an operation of lifting a restriction set for a node of the skill tree 70, an operation of unlocking a node, an operation of raising a weapon level, and an operation of breaking a limit of the weapon level. The function of the input unit 42 is implemented by the input device 26 (for example, the controller 60) illustrated in FIG. 2.

The input reception unit 43 receives the operation signal from the input unit 42. The input reception unit 43 receives, as the operation signal, a command to select a node of the skill tree 70 from the input unit 42, for example. The function of the input reception unit 43 is implemented by the input/output interface 25 illustrated in FIG. 2.

The path selection unit 44 selects a path from a start point to an end point, the start point being an unlocked node of the skill tree 70 and the end point being a locked node selected by the player through the input unit 42. In the present embodiment, a skill that the character can acquire is set for each node of the skill tree 70. Note that a node is set with a node unlocking condition. In the present embodiment, an operation of causing the character to acquire a skill set for the node by satisfying the node unlocking condition set for the node is referred to as “unlocking”. For example, consumption of a predetermined number of unlock points possessed by the character is an example of the node unlocking condition.

When a plurality of paths are present from the start point to the end point of the nodes selected from the skill tree 70 by the player, the path selection unit 44 selects a path having the smallest number of nodes. In this case, the shortest path is automatically selected from among the plurality of paths. Note that even when a locked node adjacent to the unlocked node is selected, if a plurality of paths are present, the path selection unit 44 selects the shortest path.

The character effect change unit 45 is an example of a game content effect change unit that changes the character effect of the character, which is an example of the game content, by satisfying the node unlocking condition set for each node. The character effect is an example of the above-described game effect, is set for each character, and corresponds to a skill, stats, or the like that can be acquired by the character. The skill of the character is, for example, an ability (acquiring a magic spell, stealing, dancing, or the like) unique to a job of the character, or an increase amount of an element (hit point (HP), magic point (MP), or the like) necessary for growing the character. The player unlocks the node of the skill tree 70, causing the character to acquire the skill. The stats of the character represent various states of the character at the present time, and for example, an ability that the character has acquired and can use, and a physical condition of the character (a state in which the character can normally move, a state in which the character cannot act, and the like) are assumed.

In the present embodiment, a case in which the character acquires a skill and grows is an example of a change in character effect of the character. As the character effect changes, the character may have more types of actions during a battle, or the parameter value such as the HP or MP of the character may be increased, for example. The parameters are data represented by changes of specific numerical values, and are assumed to be data represented by numerical values such as an attack power, a physical strength, and a magic power of the character in addition to the HP and MP described above. Note that the changes in character effects also include changes that result in forgoing an already acquired skill and weakening a skill.

As will be described below, in the game according to the present embodiment, a weapon enhancement node in which the character effect changes due to a change in weapon effect is provided in the skill tree 70. The weapon enhancement node is set with a restriction lifting condition for lifting restriction by the enhancement of the weapon. When the weapon effect of the weapon associated with the weapon enhancement node reaches a specified value and thus, the restriction lifting condition is satisfied, the character effect change unit 45 lifts the restriction of the weapon enhancement node. After that, when the node unlocking condition associated with the weapon enhancement node is satisfied, the character effect change unit 45 changes the character effect.

The weapon effect change unit 46 is an example of a game element effect change unit that changes the weapon effect of the weapon when a weapon unlocking condition defined for each of a plurality of weapons associated with the character is satisfied. The weapon unlocking condition refers to, for example, raising the weapon level to a specified value, breaking the limit of the weapon level, or the like. When the restriction lifting condition set for the weapon enhancement node of the skill tree 70 is to satisfy the weapon unlocking condition, the weapon effect change unit 46 lifts the restriction of the weapon enhancement node when the weapon unlocking condition is satisfied.

In the present embodiment, a weapon that can be used by the character is an example of a game element. The weapon effect is another example of the game effect described above, and corresponds to the weapon level set for each weapon. By increasing the weapon effect, that is, the weapon level, for example, the attack power of the weapon is increased, or a special technique is added to the weapon. The changes in weapon effects include changes that result in forgoing a special technique already acquired.

In the game according to the present embodiment, a weapon that can be equipped is determined for each character. Only one character can be equipped with a specific weapon, and no other character can be equipped with the same weapon. The weapon that the character possesses and can use is associated with the character, and a different weapon unlocking condition is set for each weapon. Note that weapons that can be equipped by a plurality of characters may be the same. Further, the same weapon unlocking condition may be set for a plurality of types of weapons.

The drawing unit 47 draws an image to be displayed on the output unit 49 based on the operation signal received by the input reception unit 43. Examples of the image drawn by the drawing unit 47 include text, and two-dimensional images or three-dimensional images of objects including a player character operated by the player and other characters.

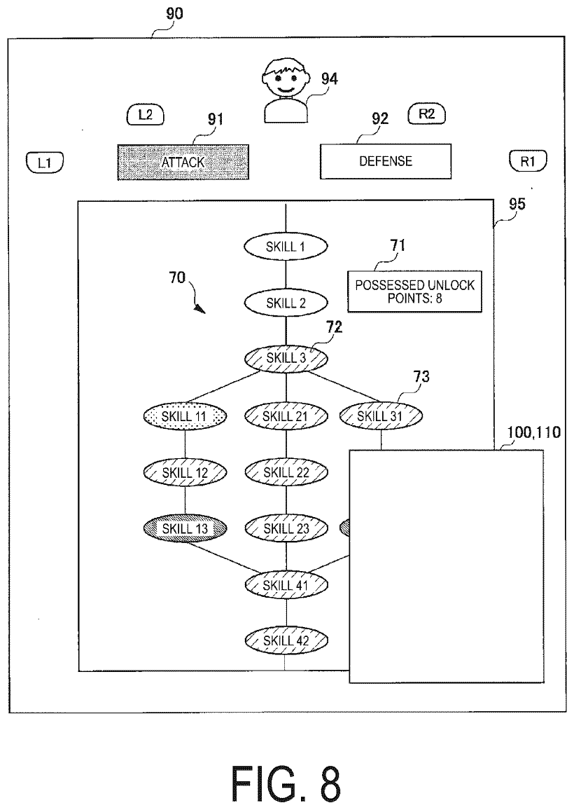

The image output unit 48 outputs the image drawn by the drawing unit 47 to the output unit 49. For example, each screen image illustrated in FIG. 8 to FIG. 12, which will be described below, is output to the output unit 49. The function of the image output unit 48 is implemented by the input/output interface 25 illustrated in FIG. 2.

The output unit 49 displays the image output by the image output unit 48. The function of the output unit 49 is implemented by the output device 27 illustrated in FIG. 2.

The storage unit 50 stores data of the game received by the communication unit 41 from the game server 1.

The function of the storage unit 50 is implemented by the storage device 22 illustrated in FIG. 2.

Both the game server 1 and the information processing terminal 2 are used as an example of the game apparatus according to the present embodiment. When the game server 1 provides the game to the information processing terminal 2, the respective functional units of the input reception unit 43, the path selection unit 44, the character effect change unit 45, the weapon effect change unit 46, and the drawing unit 47 that are included in the information processing terminal 2 are configured in the game server 1.

### External Configuration Example of Controller

FIG. 4 is a diagram illustrating an external configuration example of the controller 60.

The controller 60 is an example of a controller in which a right stick key 61, a left stick key 62, operation buttons 63, a directional pad 64, a R1 key 65, a R2 key 66, an L1 key 67, and an L2 key 68 are attached to one casing. On an upper side of FIG. 4, a plan view (1) of the controller 60 is illustrated, and on a lower side of FIG. 4, a front view (2) when the controller 60 is viewed from slightly above and from the front is illustrated.

The right stick key 61 and the left stick key 62 are used for an operation of moving the player character (hereinafter simply referred to as the “character”) to a position to which it is difficult to move the player character through an operation using the directional pad 64. The right stick key 61 and the left stick key 62 are also used for an operation of changing the viewpoint of the character.

Four buttons labeled with four types of English letters “A”, “B”, “C”, and “D” are provided as the operation buttons 63. A function for giving a command to the character is assigned to each button. The operation buttons may be labeled with numbers, figures, or the like.

The directional pad 64 is used for operations of moving the character forward, backward, leftward, and rightward. Alternatively, the directional pad 64 may be used for an operation of causing the character to squat down when the down key is pressed.

At an upper portion of the controller 60, the R1 key 65 and the R2 key 66 are provided on a right side, and the L1 key 67 and the L2 key 68 are provided on a left side. For example, each key is used for an operation in which the character calls a specific function during a battle or an operation of switching equipment of the character or display of the screen.

Note that in a tablet terminal such as the smartphone 2A (see FIG. 1) to which the controller 60 is not connected, button icons arranged in a manner similar to that of the controller 60 are displayed on the screen. The player can give an operation command equivalent to that of the controller 60 by touching the button icon. In addition, for a PC 2B to which the controller 60 is not connected (see FIG. 1), the functions of the keys and buttons of the controller 60 can be assigned to the keyboard. The player can give an operation command equivalent to that of the controller 60 by operating the keyboard.

### Configuration Example of Skill Tree

FIG. 5 is a diagram illustrating a configuration example of the skill tree 70. The skill tree 70 is formed by combining a plurality of nodes in a tree shape. Each node is connected to one or more nodes. In FIG. 5, the shape of the node is expressed as an ellipse, but may be a circle, a polygon, or the like. A possessed unlock point display section 71, which indicates unlock points possessed by the character, is displayed on the upper right side of FIG. 5. The possessed unlock point display section 71 indicates that the possessed unlock points are 8 points. The possessed unlock points are not data different for each character, but data associated with the player. Any character may use common unlock points as long as the character is used by a certain player.

In the present embodiment, the nodes constituting the skill tree 70 are an example of change factors. The change factor is displayed on the screen as the node associated with a skill that can be acquired by the character. Further, the node unlocking condition set for each node is an example of a change factor unlocking condition. Furthermore, the skill tree 70 is an example of a change element configured by a plurality of nodes, and the character operated by the player is an example of the game content. The program according to the present embodiment provides the player with the game in which the skill tree 70 is provided for each character. The node unlocking condition is set for each node of the skill tree 70, and when the node unlocking condition is satisfied, the character acquires the skill set for the node. As described above, the node unlocking condition is satisfied by consuming a predetermined number of unlock points set for each node.

When causing the character to acquire the skill, the player performs an operation of selecting a node for which the node unlocking condition is not satisfied, from among the plurality of nodes included in the skill tree 70. When the player selects the node, the path selection unit 44 illustrated in FIG. 3 sets a node satisfying the node unlocking condition as a start point, and selects a node not satisfying the node unlocking condition along a path of nodes connected to the start point.

The character effect change unit 45 allows the character to acquire the skill set for the node when the node unlocking condition of the node on the path including the selected node is satisfied. Thus, the character effect changes according to the acquired skill.

The nodes constituting the skill tree 70 include a normal node and a weapon enhancement node according to the present embodiment. A specific weapon is associated with the weapon enhancement node, and the character effect changes as the weapon effect of the specific weapon changes. Both the normal node and the weapon enhancement node are nodes that are unlocked when the node unlocking condition is satisfied by consuming a predetermined number of unlock points acquired by the character in the game, and that thus allow the character to acquire the skill.

Unlike the normal node, the weapon enhancement node is set with a restriction lifting condition that the player cannot select the weapon enhancement node unless the weapon effect of the specific weapon reaches a specified value. Thus, the weapon enhancement node requires weapon enhancement before the node unlocking condition is met. The specified value is assumed to be, for example, a value of the weapon level or a limit value of the weapon level. However, another index may be used as the specified value.

In the present embodiment, the fact that the specific weapon has been strengthened to the specified value means, for example, that the weapon level of the specific weapon has been strengthened to a specific level value, or that the limit of the weapon level of the specific weapon has been strengthened to a specific limit. After the restriction lifting condition is satisfied by the fact that the specific weapon has been strengthened to the specified value, the player can select the weapon enhancement node from the skill tree 70. When the node unlocking condition associated with the weapon enhancement node that has become selectable is satisfied, the weapon enhancement node is unlocked, and the character acquires the skill of the weapon enhancement node. For example, the player can unlock the weapon enhancement node by consuming a predetermined number of unlock points possessed by the character for the restriction-lifted weapon enhancement node, and cause the character to acquire the skill of the weapon enhancement node.

In FIG. 5, the skill that can be acquired by the character is denoted as “skill n” for each node. The “skill n” is a notation for representing a position of the node and a skill name, and in the actual skill tree 70, an image or the like indicating the skill is displayed in the node. In this case, a factor of the skill set in the node and the number of unlock points to be consumed in the node are displayed by the operation of selecting the node by the player. In addition, the same skill (for example, HP increase) may be set for different nodes (for example, the skill 2 and the skill 23).

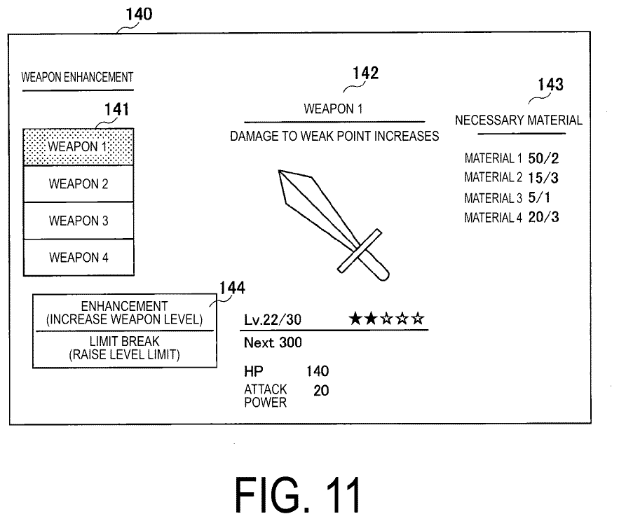

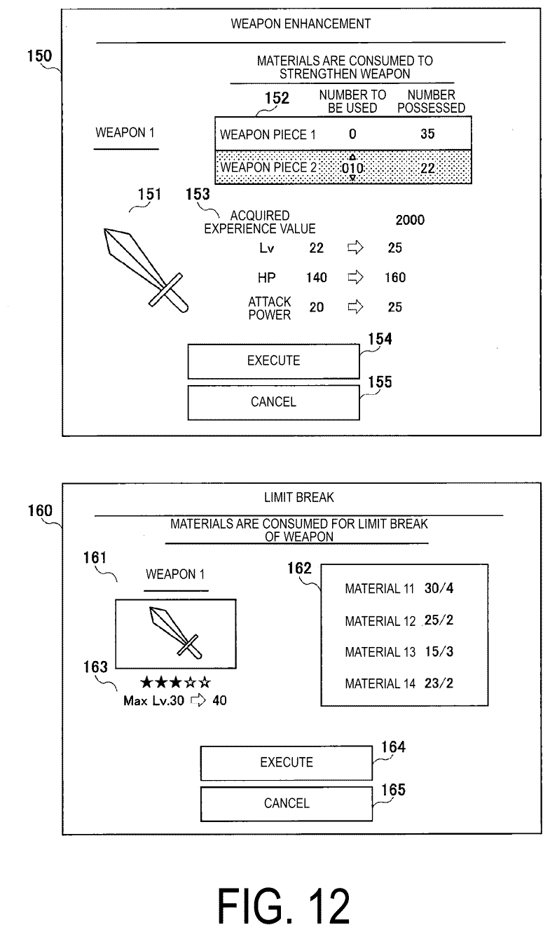

In FIG. 5, the nodes of the skills 1 and 2 are the unlocked nodes. The unlocked node is represented by an elliptical icon without hatching and without distinguishing the normal node and the weapon enhancement node. All the nodes of the skill 3 and subsequent nodes are locked nodes. Among the locked nodes, the nodes of the skills 3, 12, 21 to 23, 31, 41, and 42 represent normal nodes. The nodes of the skills 11, 13, and 32 represent weapon enhancement nodes. The weapon enhancement node of the skill 11 is locked but restriction-lifted. The weapon enhancement nodes of the skills 13 and 32 are locked and restricted. The restriction of the weapon enhancement node can be lifted on a weapon enhancement screen 140, a weapon enhancement sub-screen 150, and a limit break sub-screen 160 illustrated in FIG. 11 and FIG. 12, which will be described below.

The player performs an operation of selecting a locked node to be next unlocked, with the node of the unlocked skill 2 set as a start point. In the present embodiment, in order to unlock each node, it is necessary to consume two unlock points per node. For example, an operation of selecting the node of the skill 3, which is the locked node, by the player is equivalent to selection of a path having the node of the skill 2 as the start point and the node of the skill 3 as an end point 1. Thus, the character effect change unit 45 consumes two points from the possessed unlock points to unlock the node of the skill 3, and the character acquires the skill 3.

The player can select a plurality of nodes, or select one node by skipping a plurality of nodes. For example, the player can select the node of the skill 23 as an end point 2 and thus select a path having the node of the skill 2 as the start point and the node of the skill 23 as the end point 2. In this case, the character effect change unit 45 can collectively unlock the respective nodes of the skill 3, 21, 22, and 23 and cause the character to acquire the skills of the respective nodes. Since the number of unlock points consumed from the possessed unlock points is 8, the possessed unlock points are not in shortage.

In addition, the player can select a path having the node of the skill 2 as the start point and the node of the skill 11 as an end point 3, and unlock the nodes of the skills 3 and 11. Since the skill 11 has already been restriction-lifted, the consumption of the unlock points allows the node to be unlocked. Note that the player cannot select the weapon enhancement node of the skill 13 whose restriction is not lifted. Thus, in order for the player to select the node of the skill 41 after unlocking the nodes of the skills 3, 11, and 12, it is necessary to unlock the weapon enhancement node of the skill 13 after lifting the restriction of the weapon enhancement node of the skill 13. Alternatively, an operation of returning to the node of the unlocked skill 3 again and unlocking the nodes of the skills 21, 22, and 23 with the node of the skill 3 as a start point is necessary.

Note that it is also assumed that the skill tree 70 need not be configured such that a plurality of nodes are connected by lines, but may be configured such that the nodes are in contact with each other. Additionally, the shape of the skill tree 70 may be a radial shape instead of the tree shape. Further, the skill tree 70 is configured in a shape specific to each character, but for example, the skill tree 70 may be configured in the same shape for a plurality of characters belonging to the same group. Further, the player may select, by using a specific item, a node being at a position farther than the nodes available with the unlock points that has been acquired by the character to enable the node to be unlocked.

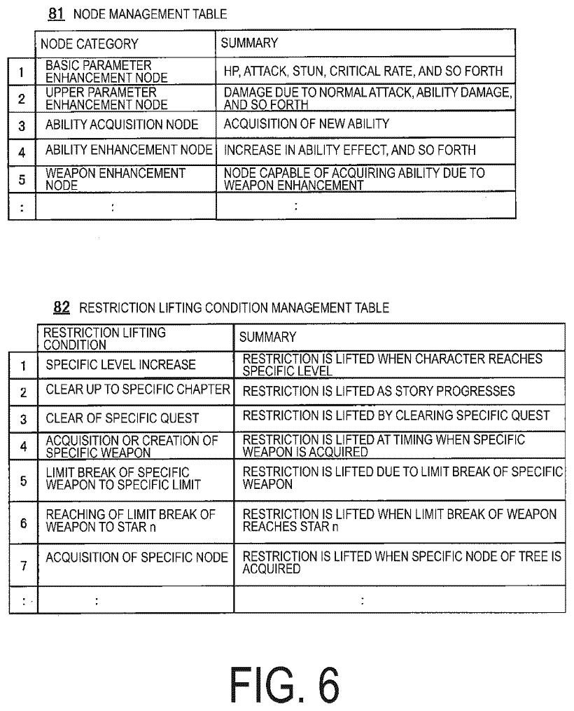

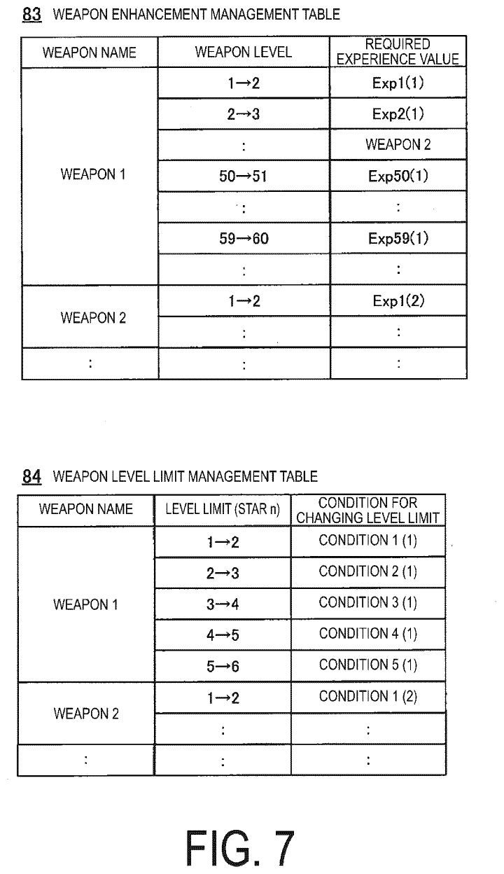

Next, a configuration example of each table managed in the game according to the present embodiment will be described with reference to FIG. 6 and FIG. 7.

FIG. 6 is a diagram illustrating a configuration example of a node management table 81 and a restriction lifting condition management table 82.

The node management table 81 is used to manage the respective nodes constituting the skill tree 70. The node management table 81 has node category and summary columns.

A node category field stores the category name of a node. Examples of the node category include “basic parameter enhancement node”, “upper parameter enhancement node”, “ability acquisition node”, “ability enhancement node”, and “weapon enhancement node”. In the present embodiment, the nodes of node categories 1 to 4 other than the “weapon enhancement node” are collectively referred to as normal nodes.

The summary field stores a summary of the node category. For example, the “basic parameter enhancement node” of the node category 1 among the node categories 1 to 4 of the normal nodes indicates a node in which basic parameters such as HP, attack, stun (temporary stunned state), and a critical rate (the probability of an attack that causes damage larger than usual) of the character are strengthened.

The “ability acquisition node” of the node category 3 indicates a new ability to be acquired by the character.

The “weapon enhancement node” of the node category 5 indicates a node in which the character can acquire the ability after strengthening the weapon possessed by the character. However, the skill that can be acquired by the character by unlocking the weapon enhancement node is not limited to the acquisition of the ability, and may be the same as or similar to the skill that can be acquired by the character by unlocking the normal node.

The restriction lifting condition management table 82 is used to manage the restriction lifting conditions set for the nodes. In the skill tree 70, both the normal node and the weapon enhancement node may be restricted. The restriction lifting condition management table 82 has columns of restriction lifting condition and summary.

The restriction lifting condition field stores a name of the restriction lifting condition. Examples of the restriction lifting condition include “specific level increase”, “clear up to specific chapter”, “clear of specific quest”, “acquisition or creation of specific weapon”, “limit break of specific weapon to specific limit”, “reaching of limit break of weapon to star n”, and “acquisition of specific node”.

The summary field stores a summary of the restriction lifting condition. Restriction lifting conditions 1 to 4 and 7 in the restriction lifting condition management table 82 represent restriction lifting conditions set for the normal nodes. For example, the restriction lifting condition 1 of “specific level increase” is a restriction lifting condition that the character reaches a specific level. The restriction lifting condition 2 of “clear up to specific chapter” is a restriction lifting condition that the game is cleared up to a specific chapter as the story progresses.

When any one of the restriction lifting conditions 1 to 4 and 7 is set for the restriction applied to the normal node, the restriction of the normal node is lifted when the set restriction lifting condition is satisfied. Thereafter, the player consumes a predetermined number of pieces of unlock content (for example, possessed points) acquired in the game and thus can unlock the normal node whose restriction has been lifted and cause the character to acquire the skill.

The restriction lifting conditions 5 and 6 represent the restriction lifting conditions of the weapon enhancement nodes. The restriction lifting condition set for the weapon enhancement node may include any one of the following: conditions that the weapon effect reaches a specified value, the weapon is acquired, and the limit of the weapon effect is broken. The fact that the weapon effect reaches the specified value indicates that the weapon level specific to the weapon reaches a specified value (for example, a weapon level 20), for example. Further, the limit break of the weapon effect means, for example, that the limit of the weapon level (for example, the limit is a weapon level 30) is broken and a new limit of the weapon level (for example, the limit is a weapon level 40) is set.

When either of the restriction lifting conditions 5 and 6 is set for the restriction applied to the weapon enhancement node, the restriction of the weapon enhancement node is lifted by satisfying the set restriction lifting condition. Thereafter, the player consumes a predetermined number of pieces of unlock content acquired in the game, and thus can unlock the weapon enhancement node whose restriction has been lifted and cause the character to acquire the skill.

For example, the restriction lifting condition 5 of “limit break of specific weapon to specific limit” is a restriction lifting condition that a specific weapon is caused to undergo limit break. The restriction lifting condition 6 of “reaching of limit break of weapon to star n” is a restriction lifting condition that the limit break of the specific weapon reaches the star n. The star n is an index indicating the strength of the weapon, for example, and the star number (n) changes like the star 1, the star 2 when the weapon is strengthened. For the same weapon, the larger the star number, the stronger the weapon. Further, since the limit value of the weapon level is restricted according to the star number, the star number of the weapon needs to be increased in order to strengthen the weapon by raising the weapon level.

FIG. 7 is a diagram illustrating a configuration example of a weapon enhancement management table 83 and a weapon level limit management table 84.

The weapon enhancement management table 83 is a table in which conditions necessary for strengthening weapons are defined. The weapon enhancement management table 83 has columns of weapon name, weapon level, and required experience value.

A weapon name field stores the name of a weapon. Note that, at the time of implementation, the weapon name may be replaced with a weapon ID assigned to each weapon.

A weapon level field stores how the weapon level changes. The weapon level is represented using a numerical value for the weapon. For example, the field indicated by “1→2” in the figure represents that the weapon level is raised from “1” to “2”.

A required experience value field stores an experience value required to raise the weapon level as a change condition required to change the weapon level. The experience value can be acquired by the character by, for example, repeating a battle using a weapon equipped by the character or using an item. The weapon level is raised by accumulating the experience value up to a threshold value determined for each weapon level. Although specific numerical values are used as the required experience values, the required experience values are denoted as Exp1(1), Exp2(1), and the like in FIG. 7. For example, the required experience value for raising the weapon level of the weapon 1 from the level 1 to the level 2 is Exp1(1). Similarly, the required experience value for raising the weapon level of the weapon 1 from the level 2 to the level 3 is Exp2(1).

As the weapon level increases, the required experience value increases.

The weapon level limit management table 84 manages the limit of the weapon level. The limit of the weapon level determined for each weapon is set in units of stars. The weapon level is determined according to the star number that can be acquired for the weapon. Thus, the player increases the star number to raise the limit of the weapon level, thereby attempting to grow the weapon used by the character to the weapon having a higher weapon level, that is, the stronger weapon or the weapon having more special effects.

The weapon level limit management table 84 has columns of weapon name, level limit (star n), and condition for changing level limit.

A weapon name field stores the name of a weapon. Note that in an actual game, the weapon name may be replaced with a weapon ID assigned to each weapon.

A level limit field stores a star number. For example, the field indicated by “1→2” in the figure represents a change in the limit of the level, and represents that the star number acquired by the weapon changes from the star 1 to the star 2. For example, when the level limit is 10 for the star 1, the player can only raise the weapon level up to 10. For the star 2, the level limit changes to 25, so that the player can raise the weapon level up to 25.

Note that the relationship between the star number and the level limit may differ for each weapon. In addition, the level limit field may store the level limit value itself instead of the star. For example, the level limit field may store a value such as 10, 25, or 35, and thus it may be possible to control the weapon effect change unit 46 to raise the weapon level only up to the value stored in the field of the level limit.

A field of the condition for changing the level limit stores a condition for changing the level limit corresponding to the star number acquired by the weapon. In this table, for example, the condition for changing the level limit necessary for changing the star 1 of the weapon to the star 2 is stored as a condition 1 (1). The condition 1 (1) defines, for example, a material type, the number of materials, a combination of materials, the number of coins in the game, and the like necessary for acquiring the star, but details thereof will not be described in the present description. In addition, in the present embodiment, the maximum value of the star number that can be acquired by the weapon is six, but the maximum value may be more or less than six. The maximum value of the star number may also be different for each weapon.

### Description of Skill Setting Screen

FIG. 8 is a diagram illustrating a display example of a skill setting screen 90.

The skill setting screen 90 is a screen on which the player can select a node from the skill tree 70. The skill setting screen 90 displays display switching tabs 91 and 92, a character icon 94, L1 and R1 button icons, L2 and R2 button icons, and a skill tree display section 95.

The character displayed in the character icon 94 can be switched by the player pressing the L2 button or the R2 button. When the character is switched, the character icon 94 corresponding to the switched character and the skill tree 70 are displayed.

The display switching tab 91 displays the skill tree 70 for attack, and the display switching tab 92 displays a skill tree for defense (not illustrated). The display switching tabs 91 and 92 can be switched by the player pressing the L1 button or the R1 button. The skill tree display section 95 displays the skill tree 70 corresponding to the display switching tabs 91 and 92 and the possessed unlock point display section 71. In FIG. 8, the display switching tab 91 is displayed in color to indicate a state in which the skill tree 70 for the attack is displayed in the skill tree display section 95. The number of unlock points (for example, “8”) currently possessed by the character is displayed in the possessed unlock point display section 71. The player can consume the possessed unlock points to cause the character to acquire the skill set in each node of the skill tree 70.

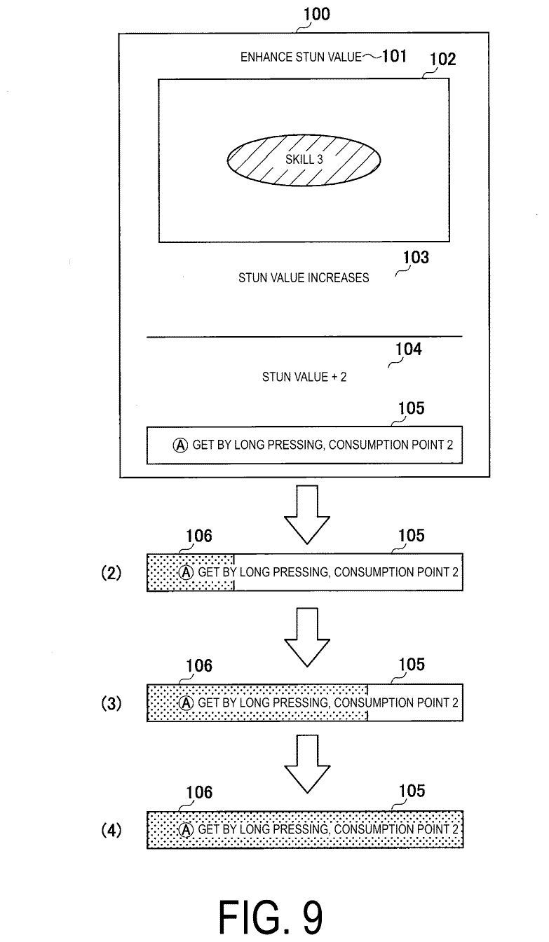

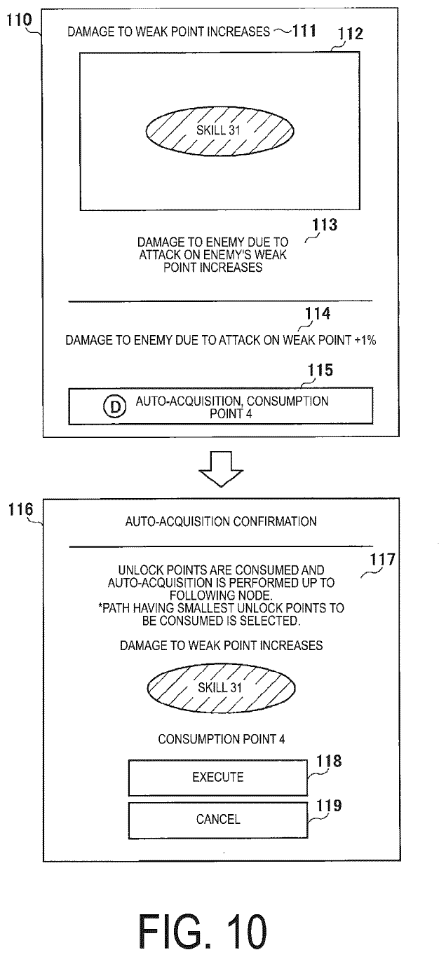

When the character acquires the skill, a sub-screen illustrated in FIG. 9 or 10, which will be described below, is displayed on the skill setting screen 90 in an overlapping manner, according to the number of locked nodes existing on a path having an unlocked node as a start point and a locked node as an end point. When one locked node existing on the path, that is, the locked node adjacent to the unlocked node is selected, a skill acquisition sub-screen 100 illustrated in FIG. 9 is displayed. On the other hand, when a plurality of locked nodes are present on the path, that is, when a locked node that is present two or more nodes ahead relative to the unlocked node is selected, a multi-skill acquisition sub-screen 110 illustrated in FIG. 10 is displayed. These sub-screens will be described below.

### Display Example of Skill Acquisition Sub-Screen

FIG. 9 is a diagram illustrating a display example of the skill acquisition sub-screen 100. The skill acquisition sub-screen 100 is displayed on the skill setting screen 90 illustrated in FIG. 8 in an overlapping manner. For example, the skill acquisition sub-screen 100 displayed when the locked node 72 with the skill 3 in FIG. 8 is selected will be described.

(1) in FIG. 9 is an enlarged view of the skill acquisition sub-screen 100. The skill acquisition sub-screen 100 includes a skill name display section 101, a selected node display section 102, a first skill effect explanation section 103, a second skill effect explanation section 104, and a specific operation display section 105.

The skill name display section 101 displays a skill name associated with the locked node 72 selected by the player.

The selected node display section 102 displays an enlarged image of the locked node 72.

The first skill effect explanation section 103 displays the explanation of a skill effect.

The second skill effect explanation section 104 displays the explanation of the skill effect together with a specific numerical value.

The specific operation display section 105 displays a first specific operation for the player to cause the character to acquire a skill, and the number of points to be consumed for the character to acquire the skill. The character effect change unit 45 changes the character effect when the first specific operation is performed via the input unit 42 after the locked node 72 not satisfying the node unlocking condition is selected by an operation of the player, and the node unlocking condition associated with the locked node 72 is satisfied. In the present embodiment, as the first specific operation, an operation of pressing an A button among the operation buttons 63 of the controller 60 illustrated in FIG. 4 for a specified period of time or longer (referred to as “long pressing”) is adopted. Further, the node unlocking condition associated with the locked node 72 is, for example, that two points are consumed from the possessed unlock points. Note that long pressing of a button other than the A button may be adopted as the first specific operation, or an operation of pressing the A button a plurality of times in succession may be adopted as the first specific operation.

For example, when the player presses the A button, a skill acquisition gauge 106 whose shape is changed according to the number of seconds for which the A button is being pressed for a long time is displayed so as to be superimposed on the icon of the specific operation display section 105. The skill acquisition gauge 106 is represented by an animation extending from the left to the right of the icon of the specific operation display section 105 according to a time length when the player is pressing the A button for a long time.

In (1) in FIG. 9, the skill acquisition gauge 106 is not displayed because the player does not press the A button. In (2) and (3) in FIG. 9, the player presses the A button for a long time, and thus the skill acquisition gauge 106 extends from the left end of the icon of the specific operation display section 105.

As illustrated in (4) in FIG. 9, when the extended skill acquisition gauge 106 reaches the right end of the icon of the specific operation display section 105, the character acquires the skill.

Note that, when the player stops the operation of pressing the A button before the skill acquisition gauge 106 reaches the right end of the icon of the specific operation display section 105 (at the timings of (2) or (3) in FIG. 9), the display of the skill acquisition gauge 106 is ended. In this case, the unlock points are not consumed and the character does not acquire the skill. This operation corresponds to a cancel operation of stopping the acquisition of the skill after the player determines the skill to be acquired by the character.

### Display Example of Multi-Skill Acquisition Sub-Screen

FIG. 10 is a diagram illustrating a display example of the multi-skill acquisition sub-screen 110. The multi-skill acquisition sub-screen 110 is displayed so as to be superimposed on the skill setting screen 90 illustrated in FIG. 8. As an example, the multi-skill acquisition sub-screen 110 displayed when the locked node 73 of the skill 31 in FIG. 8 is selected will be described.

The multi-skill acquisition sub-screen 110 illustrated on the upper side of FIG. 10 includes a skill name display section 111, a selected node display section 112, a first skill effect explanation section 113, a second skill effect explanation section 114, and a specific operation display section 115.

The skill name display section 111 displays a skill name associated with the locked node 73.

The selected node display section 112 displays an enlarged image of the locked node 73.

The first skill effect explanation section 113 displays the explanation of a skill effect.

The second skill effect explanation section 114 displays the explanation of the skill effect together with a specific numerical value.

The specific operation display section 115 displays a second specific operation for the player to cause the character to acquire a skill, and the number of points to be consumed for the character to acquire the skill. The character effect change unit 45 changes the character effect by consuming the unlock points when a plurality of locked nodes including the locked node 73 selected by the player are present on the path, and at the same time, when the second specific operation is performed via the input unit 42, and the node unlocking conditions associated with the plurality of locked nodes are satisfied. This makes it possible for the character to collectively acquire a plurality of skills each associated with a respective one of the plurality of locked nodes. Further, the player does not have to perform an operation of selecting a plurality of locked nodes one by one and pressing each of the nodes for a long time, thereby causing a period of time required for unlocking the plurality of locked nodes to be shortened. The processing of collectively unlocking the locked nodes that exist on the path automatically selected by the path selection unit 44 illustrated in FIG. 3 and causing the character effect change unit 45 to allow the character to acquire a plurality of skills is referred to as “auto-acquisition”.

In the present embodiment, as the second specific operation, an operation of pressing the D button of the operation buttons 63 of the controller 60 illustrated in FIG. 4 is adopted. In the specific operation display section 115, “auto-acquisition” is displayed together with the icon of the D button. Moreover, the node unlocking condition associated with the locked node is, for example, that four points are consumed from the possessed unlock points in order to unlock all the locked nodes with the skills 3 and 31 on the path. Note that pressing a button other than the D button may be adopted as the second specific operation.

A confirmation screen 116 illustrated in the lower side of FIG. 10 is displayed when the D button is pressed and the auto-acquisition is commanded. For the auto-acquisition, many unlock points are consumed. Because of this, the confirmation screen 116 is displayed to enable the operation to be canceled when the player selects a locked node with an unintended skill.

The confirmation screen 116 includes an operation explanation display section 117, an execution button 118, and a cancel button 119.

The operation explanation display section 117 displays the fact that the player consumes the unlock points and acquires the skills by the auto-acquisition up to the node selected by the player, the fact that the path with the minimum unlock points to be consumed is selected, the image of the locked node 73 selected by the player, and the total number of unlock points to be consumed.

The execution button 118 is a button for the player to give an instruction of the execution of the auto-acquisition.

When the execution button 118 is pressed, the plurality of locked nodes are unlocked, and the character acquires the skills.

The cancel button 119 is a button for the player to give a command of cancellation of the execution of the auto-acquisition. When the cancel button 119 is pressed, the auto-acquisition is not performed, and the multi-skill acquisition sub-screen 110 is closed.

### Description of Weapon Enhancement Screen

FIG. 11 is a diagram illustrating a display example of a weapon enhancement screen 140.

The weapon possessed by the character can be strengthened by using, for example, an experience value or a material. The weapon enhancement screen 140 is a screen for the player to strengthen the weapon by using an experience value or a material. The weapon enhancement screen 140 includes a weapon enhancement target selection section 141, a weapon enhancement target information display section 142, a required material display section 143, and a weapon effect selection section 144.

The weapon enhancement target selection section 141 is used for selecting a weapon that the player wants to strengthen. In FIG. 11, four types of weapons, that is, the weapon 1 to the weapon 4, are selectable, and the entry of the weapon 1 selected as a weapon to be strengthened is displayed in a colored manner.

The weapon enhancement target information display section 142 displays information regarding the weapon selected on the weapon enhancement target selection section 141. Examples of the information regarding the weapon include an image representing the weapon selected on the weapon enhancement target selection section 141, a current level of the weapon, a limit level of the weapon, the number of stars acquired by the weapon, an experience value required for the weapon to reach the next level, an HP of the weapon, and an attack power of the weapon. The HP of the weapon is added to the HP of the character. Further, the attack power of the weapon is added to an attack power of the character.

The required material display section 143 displays materials required for changing the weapon effect of the weapon selected by the weapon enhancement target selection section 141.

In the weapon effect selection section 144, entries of two types of methods for changing the weapon effect are displayed in a selectable manner. The two types of methods include “enhancement” for raising the weapon level and “limit break” for raising the limit of the weapon level. According to the entry selected by the player, either the weapon enhancement sub-screen 150 or the limit break sub-screen 160 illustrated in FIG. 12 is displayed.

### Description of Weapon Enhancement Sub-Screen and Limit Break Sub-Screen

FIG. 12 is a diagram illustrating a display example of the weapon enhancement sub-screen 150 and the limit break sub-screen 160. When the entry of “enhancement” of the weapon effect selection section 144 is selected, the weapon enhancement sub-screen 150 illustrated on the upper side of FIG. 12 is displayed so as to be superimposed on the weapon enhancement screen 140 illustrated in FIG. 11.

The weapon enhancement sub-screen 150 includes a weapon icon display section 151, an enhancement material selection section 152, an enhancement result display section 153, an execution button 154, and a cancel button 155.

The weapon icon display section 151 displays the image icon of a weapon selected by the player for enhancement.

The enhancement material selection section 152 displays the number of materials currently possessed and the number of materials to be used, regarding materials required for strengthening the selected weapon. The material selected by the player is highlighted, and the number of materials to be used can be changed. In the enhancement material selection section 152, currency or the like to be used in the game may be displayed and consumed as the enhancement material.

The enhancement result display section 153 displays an experience value that can be acquired by strengthening the weapon, and current values and enhanced values of the weapon level, the HP, and the attack power. The player can determine whether to strengthen the weapon by checking each value of the enhancement result display section 153.

The execution button 154 is a button for the player to give a command for the execution of weapon enhancement. When the execution button 154 is pressed, the number of materials displayed in the enhancement material selection section 152 are used, thereby raising the weapon level.

The cancel button 155 is a button for the player to give a command for cancellation of the execution of weapon enhancement. When the cancel button 155 is pressed, the weapon is not strengthened, and the weapon enhancement sub-screen 150 is closed.

When the entry of “limit break” of the weapon effect selection section 144 is selected, the limit break sub-screen 160 illustrated on the lower side of FIG. 12 is displayed so as to be superimposed on the weapon enhancement screen 140 illustrated in FIG. 11.

The limit break sub-screen 160 includes a weapon icon display section 161, a limit break material display section 162, a limit break result display section 163, an execution button 164, and a cancel button 165.

The weapon icon display section 161 displays an image icon of a weapon selected by the player for limit break.

The limit break material display section 162 displays, regarding materials required for the limit break of the selected weapon, the number of materials currently possessed and the number of materials to be used, for example, in a form of the number possessed/the number to be used.

The limit break result display section 163 displays the number of stars that can be acquired by breaking the limit of the weapon, a current value of the limit of the weapon level, and a value after the limit break. The player can determine whether to break the limit of the weapon by checking each value of the limit break result display section 163.

The execution button 164 is a button for the player to give a command for execution of the limit break. When the execution button 164 is pressed, the materials displayed in the limit break material display section 162 are used in the displayed numbers, and the limit break of the selected weapon is executed.

The cancel button 165 is a button for the player to give a command for cancellation of the execution of the limit break. When the cancel button 165 is pressed, the limit break is not executed, and the limit break sub-screen 160 is closed.

### Example of Processing Performed in Game

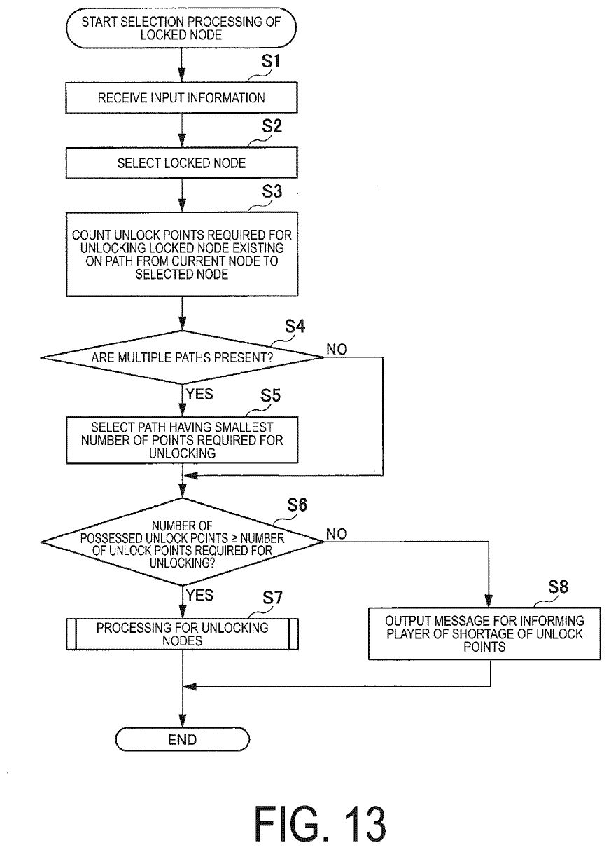

Next, details of processing performed in the game will be described with reference to FIG. 13 to FIG. 15.

In the following processing, an effect change method of a character and a weapon in the game according to the present embodiment will be described.

### Example of Processing for Selecting Locked Node

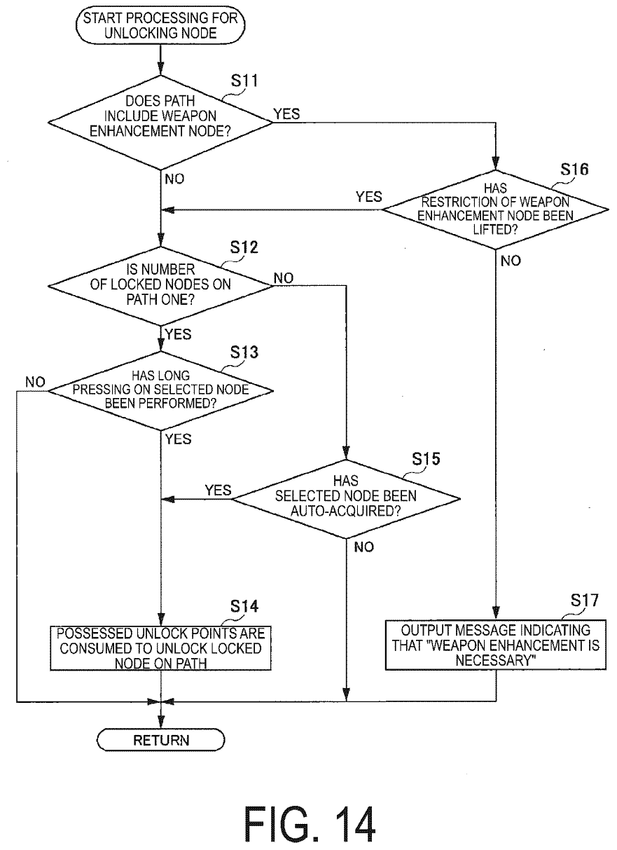

First, an example of processing in which a character is caused to acquire a skill by referring to the skill tree 70 illustrated in FIG. 5 and FIG. 8 will be described with reference to FIG. 13 and FIG. 14. In the following description, it is assumed that the display switching tab 91 for “attack” on the skill setting screen 90 illustrated in FIG. 8 is selected and the skill tree 70 corresponding to “attack” is displayed on the output device 27 by the image output unit 48.

FIG. 13 is a flowchart illustrating an example of processing for selecting a locked node.

First, when the player operates the controller 60 (see FIG. 4), which is an example of the input device 26, to perform an operation of selecting a node, the input unit 42 illustrated in FIG. 3 generates an operation signal, and the input reception unit 43 receives an operation signal as input information (S1). Hereinafter, a series of processing operations of the controller 60, the input unit 42, and the input reception unit 43 in step S1 will be described simply as an operation of the controller 60.

Next, the player operates the controller 60 to select a locked node from the skill tree 70 (S2). The player selects a locked node with an unlocked node as a start point. The number of nodes that can be selected by the player may be only one, or a plurality of nodes may be selected. Further, the node that can be selected by the player is not limited to a locked node adjacent to the unlocked node, and may be a locked node located a plurality of nodes ahead of the unlocked node.

Next, the path selection unit 44 illustrated in FIG. 3 counts the unlock points necessary for unlocking locked nodes existing on the path from the current node to the node selected by the controller 60 (S3). For example, it is assumed that the number of unlock points required for each node to reach another adjacent node is “2”. In this case, when two locked nodes exist on the path from the current unlocked node to the locked node selected by the controller 60, the path selection unit 44 calculates the unlock points necessary for unlocking as 2×2=4 points.

Next, the path selection unit 44 determines whether a plurality of paths exist from the current node to the selected locked node (S4). When only one path exists (NO in S4), the processing proceeds to step S6. The one path corresponds to, for example, not only a path in a case where only one path exists from the current node to the selected locked node with a plurality of locked nodes interposed therebetween, but also corresponds to the path to the locked node adjacent to the current node.

On the other hand, when a plurality of paths exist (YES in S4), the path selection unit 44 selects a path having the smallest number of points required for unlocking among the plurality of paths (S5). For example, in the skill tree 70 illustrated in FIG. 5, it is assumed that the restriction of the node of the skill 32 has been lifted. It is also assumed that the player selects the current node of the unlocked skill 2 as a start point and the node of the skill 41 as an end point. In this case, a path 1 that follows the nodes of the skills 3, 21, 22, and 23 and a path 2 that follows the nodes of the skills 3, 31, and 32 are present from the node of the skill 2 to the node of the skill 41. The number of points required for unlocking the path 1 is “10”, and the number of points required for unlocking the path 2 is “8”. Thus, the path selection unit 44 selects the path 2 having the smaller number of points required for unlocking.

After the processing of step S5 or after the determination of NO in step S4, the character effect change unit 45 illustrated in FIG. 3 determines whether the number of possessed unlock points is equal to or larger than the number of unlock points necessary for unlocking the nodes on the path (S6). The determination processing of step S6 represents a condition for unlocking the nodes, and is an example of the change factor unlocking condition.

When the number of possessed unlock points is equal to or more than the number of unlock points necessary for unlocking the nodes on the path (YES in S6), the character effect change unit 45 performs processing for unlocking the nodes illustrated in FIG. 14 (S7), which will be described below, and then ends the processing.

On the other hand, when the number of possessed unlock points is less than the number of unlock points necessary for unlocking the nodes on the path (NO in S6), the character effect change unit 45 outputs a message for indicating the shortage of the number of unlock points (S8), and ends the present processing. The player who is notified of the shortage of the number of possessed unlock points performs an operation of selecting a locked node again, and thus the processing is repeated from step S1.

### Example of Processing for Unlocking Nodes

FIG. 14 is a flowchart illustrating an example of processing for unlocking nodes. The processing for unlocking nodes is the subroutine illustrated in step S7 of FIG. 13.

First, the character effect change unit 45 determines whether a weapon enhancement node is included on the path selected by the path selection unit 44 (S11). When no weapon enhancement node is included on the path (NO in S11), the character effect change unit 45 determines whether the number of locked nodes on the path is one (S12).

When only one locked node exists on the path (YES in S12), the character effect change unit 45 determines whether the node selected by the player has been pressed for a long time (the first specific operation) (S13). When the long pressing is not performed (NO in S13), the processing is not performed. In this case, in FIG. 13, the processing for unlocking the nodes in step S7 is ended.

On the other hand, when the long pressing is performed (YES in S13), the character effect change unit 45 consumes the possessed unlock points to unlock the locked nodes on the path (S14). When only one locked node exists on the path, only the one locked node is unlocked, and the processing for unlocking the nodes in step S7 in FIG. 13 is ended.

In step S12, when a plurality of unlocked nodes exist on the path (NO in S12), the character effect change unit 45 determines whether the operation for auto-acquisition (the second specific operation) has been performed on the locked node selected by the player (S15). When the operation for auto-acquisition (the second specific operation) is performed (YES in S15), the processing proceeds to step S14.

In step S14 after the determination of YES in step S15, the processing for the auto-acquisition is executed. For example, a path is assumed on which a node satisfying the node unlocking condition is a start point, and a locked node on which long pressing is to be performed and in which the node unlocking condition has not been satisfied yet is an end point.

A case may occur where one or more locked nodes in which the node unlocking conditions have not been satisfied yet exist on the path and the node unlocking conditions of the one or more locked nodes existing on the path and the locked node as the end point are satisfied.

In this case, the path selection unit 44 collectively changes the character effects of the plurality of locked nodes existing on the path and the character effect of the locked node as the end point. Thus, a plurality of locked nodes on the path are unlocked by only one operation of the auto-acquisition (pressing of the D button), and the time and effort of the player for performing the long pressing operation several times are reduced.

In step S11, in determining that the weapon enhancement node is included on the path (YES in S11), the character effect change unit 45 determines whether the restriction of the weapon enhancement node has been lifted (S16). Any one of the node unlocking conditions 4 to 6 in the restriction lifting condition management table 82 illustrated in FIG. 6 is set for the weapon enhancement node, and the restriction of the weapon enhancement node is lifted when the set restriction lifting condition is satisfied. As described above, when the specific weapon associated with the weapon enhancement node is strengthened up to the specified value, the restriction lifting condition is satisfied and the restriction of the weapon enhancement node is lifted.

In a case where the restriction of the weapon enhancement node has been lifted (YES in S16), the processing proceeds to step S12.

On the other hand, in a case where the restriction of the weapon enhancement node has not been lifted (NO in S16), the character effect change unit 45 outputs a message indicating that “weapon enhancement is necessary” (S17), and the processing for unlocking the nodes in step S7 in FIG. 13 is ended. The player who has seen the message recognizes that the locked node on the path cannot be unlocked at the current situation, and performs an operation of lifting the restriction of the weapon enhancement node.

### Example of Processing for Weapon Enhancement

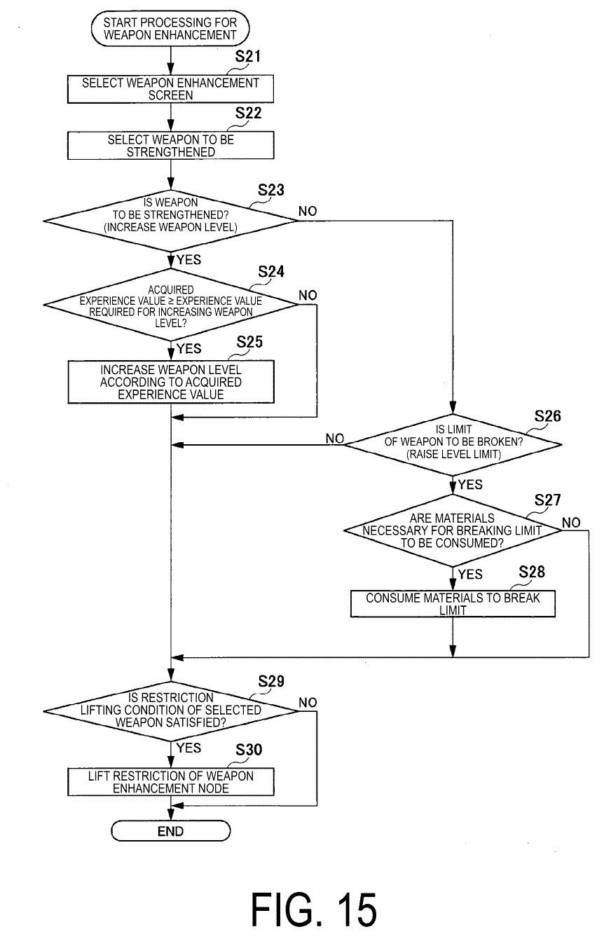

FIG. 15 is a flowchart illustrating an example of processing for weapon enhancement. The processing for weapon enhancement is processing that is performed through the weapon enhancement screen 140 illustrated in FIG. 11, and the weapon enhancement sub-screen 150 and the limit break sub-screen 160 illustrated in FIG. 12.

First, the player operates the controller 60 to select the weapon enhancement screen 140 (S21). Next, the player selects a weapon to be strengthened from the weapon enhancement target selection section 141 (S22). Next, the player determines whether to strengthen the weapon (S23). The weapon enhancement is to raise the weapon level.

When the player determines to strengthen the weapon (YES in S23), the player selects the entry of “enhancement” of the weapon effect selection section 144. When the entry of “enhancement” is selected, the weapon enhancement sub-screen 150 is displayed. The weapon effect change unit 46 displays materials necessary for raising the weapon level on the weapon enhancement sub-screen 150.

Next, the player selects the number of materials to be used from the materials necessary for raising the weapon level, and checks the experience value that will be acquired through the raising of the weapon level. Thereafter, the weapon effect change unit 46 determines whether the acquired experience value is equal to or larger than an experience value required for raising the weapon level (S24).

When the acquired experience value is equal to or larger than the experience value required for raising the weapon level (YES in S24), the weapon effect change unit 46 raises the weapon level according to the acquired experience value (S25), and the processing proceeds to step S29. On the other hand, when the acquired experience value is less than the experience value required for raising the weapon level (NO in S24), the weapon effect change unit 46 does not raise the weapon level, and the processing proceeds to step S29.

In step S23, when the player determines not to strengthen the weapon (NO in S23), the player determines whether to cause the weapon to undergo limit break (to raise the level limit) (S26). When the player determines to cause the weapon to undergo the limit break (YES in S26), the player selects the entry of “limit break” of the weapon effect selection section 144. When the entry of “limit break” is selected, the limit break sub-screen 160 is displayed. The weapon effect change unit 46 causes the materials necessary for the limit break to be displayed on the limit break sub-screen 160. The player checks the number of materials to be used that is necessary for the limit break.

Next, the player determines whether to consume the materials necessary for the limit break to break the limit (S27). When the materials are consumed to break the limit (YES in S27), the weapon effect selection section 144 breaks the limit by consuming the materials necessary for the limit break (S28), breaks the limit of the weapon level, and proceeds to step S29.

After the determination of NO in step S24, step S25, the determination of NO in step S26, the determination of NO in step S27, or step S28, the weapon effect selection section 144 determines whether the restriction lifting condition of the selected weapon is satisfied (S29). When the restriction lifting condition of the selected weapon is not satisfied (NO in S29), the weapon effect selection section 144 does not lift the restriction of the weapon enhancement node, and ends the present processing.

On the other hand, when the restriction lifting condition of the selected weapon is satisfied (YES in S29), the weapon effect selection section 144 lifts the restriction of the weapon enhancement node (S30), and ends the present processing. Even a weapon that does not satisfy the restriction lifting condition before the present processing may satisfy the restriction lifting condition by raising the weapon level in step S25 or breaking the limit of the weapon level in step S28.

In the game system 10 according to the first embodiment described above, the skill tree 70 illustrated in FIG. 5 is provided with the weapon enhancement nodes each of which requires enhancement of a specific weapon before unlocking, in addition to the normal nodes. When the weapon level of a specific weapon set for each character or the state of limit break reaches a specified value, the restriction lifting condition is satisfied, and the weapon enhancement node can be unlocked. Thus, when a weapon enhancement node is provided in front of a locked node set with a skill that the player wants the character to acquire, the player strengthens a weapon corresponding to the weapon enhancement node. The player can also cause the character to acquire the skill associated with the weapon enhancement node by consuming a predetermined number of possessed unlock points for the locked and restriction-lifted weapon enhancement node, and thus unlocking the weapon enhancement node.

In this manner, when the weapon enhancement nodes are provided in the skill tree 70, the player can continue to be motivated to raise the weapon levels of various weapons or to break the limits of the weapons in order to cause the character to acquire various skills. The player causes the character to acquire a skill by strengthening a specific weapon associated with the character. Since the character can permanently retain the acquired skill, it is not wasted that the player has strengthened the specific weapon. Thus, after the player causes the character to acquire a target skill, the player can promote weapon change in which the weapon currently used by the character is changed into another weapon.

A player of an existing game performs an operation of continuously using only a weapon acquired by a character in an early stage of a story in a strengthened manner, for example, and thus, in some cases, the player does not use another weapon prepared. On the other hand, in the game provided by the game system 10 according to the present embodiment, weapon enhancement nodes are provided in the skill tree 70, and various weapons are associated with the weapon enhancement nodes according to the arrangement locations in the skill tree 70. Thus, it is expected that the player strengthens various weapons, tries out a weapon, and enjoys the performance of a weapon effect.

Further, the operation performed on locked nodes to be unlocked by the player differs depending on a position where the unlocked node is set as a start point. When a locked node adjacent to the unlocked node serving as the start point is selected, the player can unlock the node by pressing the A button of the controller 60 for a long time. In addition, when a locked node located at a position away from the unlocked node serving as the start point is selected, locked nodes on a path with a small consumption amount of unlock points are collectively unlocked by the auto-acquisition. This causes the time required for unlocking a plurality of locked nodes to be reduced.

Note that in the first embodiment described above, an example in which the weapon enhancement nodes related to weapon enhancement are set in the skill tree 70 has been described. In addition to the enhancement of the weapon, a weapon enhancement node that can be unlocked by a change such as weakening of the weapon may be set in the skill tree 70. As well as the weapon, a weapon enhancement node that can be unlocked by a change including strengthening or weakening of protective equipment or an item may be set in the skill tree 70.

In the first embodiment described above, the player selects a node in the skill tree 70, but the path selection unit 44 may automatically select a node. For example, a node that is advantageous for the progress of the story is automatically selected, allowing even a player who is not familiar with the game to easily progress the game.

### Modified Example of Skill Tree

In the first embodiment described above, the skill tree 70 displayed on the skill setting screen 90 includes the normal nodes and the weapon enhancement nodes. In addition to the weapon enhancement nodes, a node for which acquisition of protective equipment or an item that is used in the game is a restriction lifting condition may be included in the skill tree 70. Hereinafter, a skill setting screen 90A including a skill tree 70A, which is a modified example of the skill tree 70, will be described.

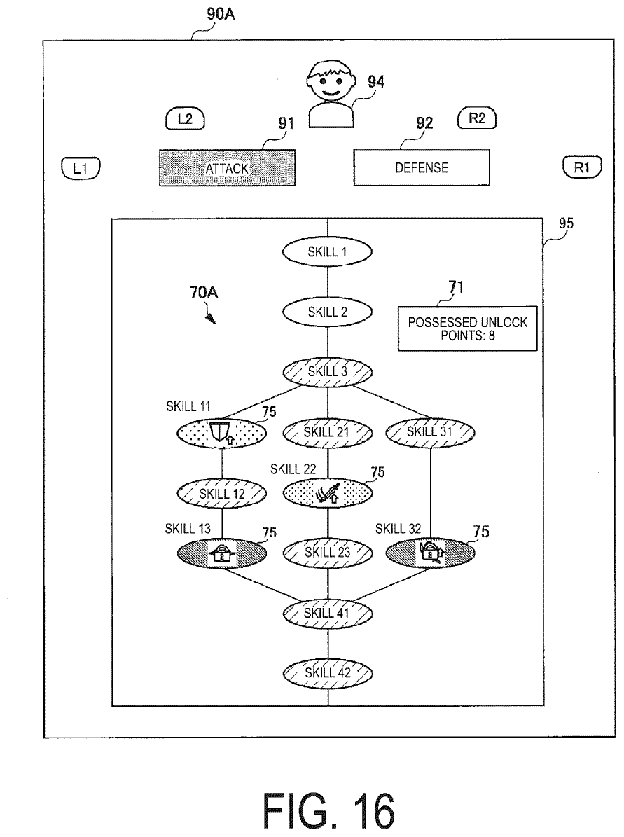

FIG. 16 is a diagram illustrating a display example of the skill setting screen 90A according to the modified example of the first embodiment. The skill tree 70A according to the modified example is displayed in the skill tree display section 95 of the skill setting screen 90A.

The skill tree 70A is formed by combining a plurality of nodes, similarly to the skill tree 70 illustrated in FIG. 5. Enhancement nodes 75 are included as specific nodes in some nodes of the skill tree 70A. For example, the nodes of the skills 11, 13, 22, and 32 are the enhancement nodes 75. In the present modified example, protective equipment, an item, or the like that can be used by a character is an example of a game element. Thus, not only a weapon but also protective equipment or an item may be associated with the enhancement node 75. For example, the enhancement nodes 75 of the skills 22 and 32 are associated with weapons. The enhancement node 75 of the skill 11 is associated with protective equipment. The enhancement node 75 of the skill 13 is associated with an item.

The enhancement node 75 is set with a node unlocking condition and a restriction lifting condition. After the weapon or protective equipment associated with the enhancement node 75 is strengthened or the item associated with the enhancement node 75 is used to lift the restriction of the weapon enhancement node, the enhancement node 75 is unlocked when a predetermined number of unlock points are consumed. Thereafter, the character acquires the skill set in the enhancement node 75.

Note that a skill tree displayed when the display switching tab 92 of “defense” is selected may have a configuration similar to that of the skill tree 70A displayed when the display switching tab 91 of “attack” is selected.

### Second Embodiment

Next, a game system according to a second embodiment of the present invention will be described. In this game system, a display switching tab capable of newly displaying a weapon enhancement bonus screen is provided on the skill setting screen.

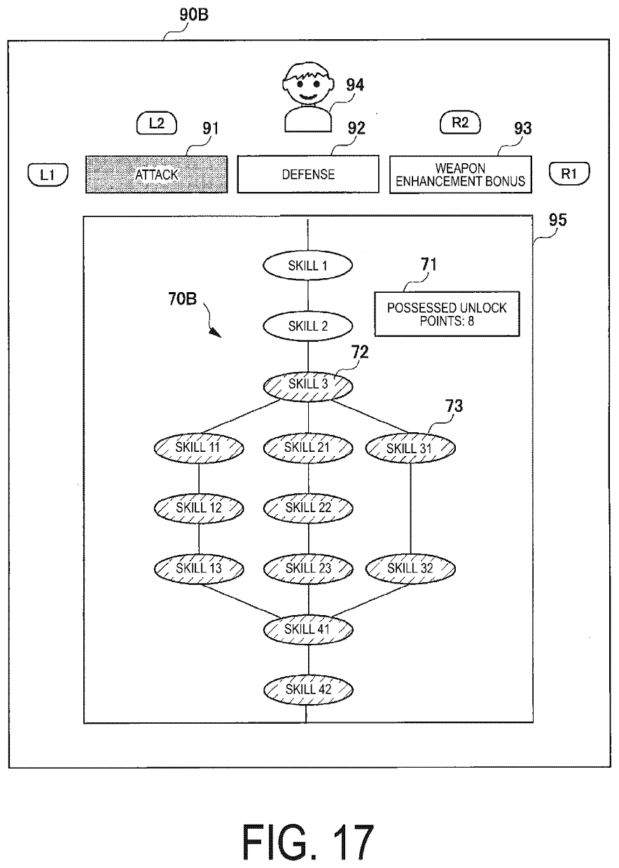

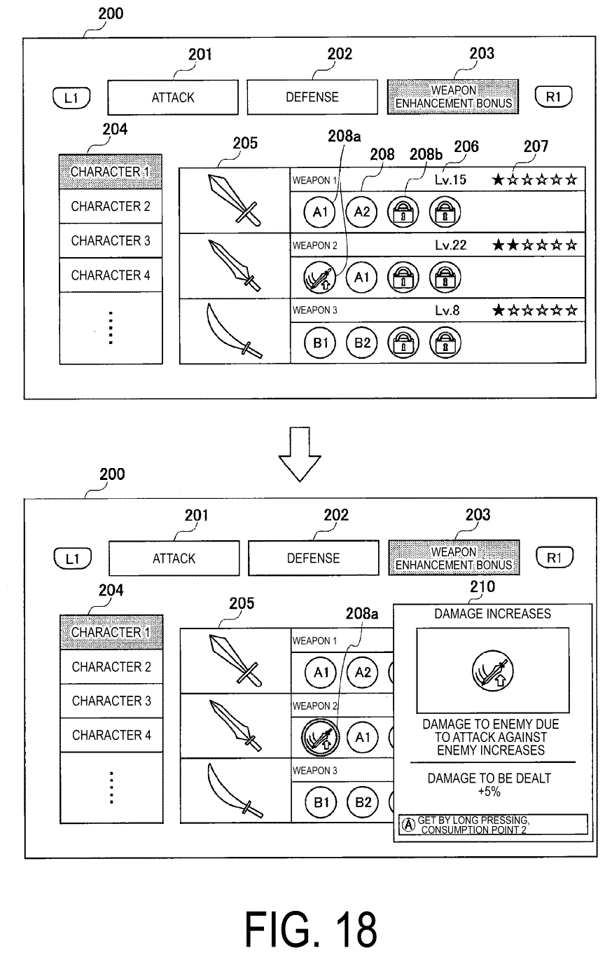

FIG. 17 is a diagram illustrating a display example of a skill setting screen 90B according to the second embodiment. In the present embodiment, the skill setting screen 90B (an example of a first screen) on which a skill tree 70B is drawn and a weapon enhancement bonus screen 200 (an example of a second screen) illustrated in FIG. 18, which will be described below, are configured to be switchable. Thus, display switching tabs 91 to 93 are displayed in an upper part of the skill setting screen 90B. The display switching tab 93 is used to switch the display from the skill setting screen 90B to the weapon enhancement bonus screen 200.

The skill tree 70B displayed in the skill tree display section 95 is different from the skill tree 70 according to the first embodiment, and is constituted only by normal nodes. When the player strengthens a weapon and acquires a skill associated with the weapon, the player performs an operation of pressing the display switching tab 93 added to the upper part of the skill setting screen 90B to display the weapon enhancement bonus screen 200.

### Description of Weapon Enhancement Bonus Screen

FIG. 18 is a diagram illustrating a display example of the weapon enhancement bonus screen 200.

The weapon enhancement bonus screen 200 is displayed when the display switching tab 93 of the skill setting screen 90B is selected. The display switching tabs 201 to 203 in the upper part of the weapon enhancement bonus screen 200 are the same as the display switching tabs 91 to 93 illustrated in FIG. 17. In FIG. 18, the weapon enhancement bonus screen 200 is displayed by coloring the display switching tab 203.

A character selection section 204 is displayed on the left side of the weapon enhancement bonus screen 200. The character selection section 204 displays the character names of characters that can be used by the player, such as a “character 1”. The player selects a character possessing a weapon to be strengthened from the character selection section 204. For example, when the character 1 is selected, the entry of the character 1 is displayed in a colored manner.

The weapon information display section 205 displays a list of information regarding weapons that can be equipped by the character. The weapon unlocking condition according to the second embodiment is the same as the weapon unlocking condition according to the first embodiment. In the weapon information display section 205, for each weapon, a weapon icon, a weapon name, a weapon level, the number of stars acquired by the weapon, and a plurality of circular nodes indicating skills associated with the weapon are displayed. A node displayed on the weapon enhancement bonus screen 200 is not an elliptical shape as in the skill tree 70 (see FIG. 5), but is illustrated as an example of the second change element that can be freely selected by the player.

The weapon name is, for example, a name such as the “weapon 1”. The weapon level is displayed in the weapon level display section 206 as “Lv. 15”, for example. The number of stars acquired by the weapon is represented by the number of colored star icons displayed in the star display section 207. For example, the number of colored star icons of the weapon 1 is “1”, and thus it can be seen that the weapon 1 has reached the “star 1”.

The skills that the character can acquire are displayed as weapon enhancement nodes in the skill display section 208. In addition to the skill name, an image representing the skill may be displayed in the weapon enhancement node. It should be noted that the weapon enhancement node may be restricted. The weapon enhancement node 208a illustrated in FIG. 18 is different in display form from the weapon enhancement node (for example, the node of the skill 11) of the skill tree 70 illustrated in FIG. 5, but is the same in that the restriction is lifted by the weapon enhancement. The skill of the restricted weapon enhancement node is illustrated in the restricted weapon enhancement node 208b together with the image of a lock. The player cannot select the restricted weapon enhancement node 208b.

A restriction-lifted skill, or skill that is originally not restricted, is illustrated in a restriction-lifted weapon enhancement node 208a without the image of the lock. The player can select the restriction-lifted weapon enhancement node 208a to allow the character to acquire the skill. On the lower side of FIG. 18, an example is illustrated in which one of the restriction-lifted weapon enhancement nodes 208a has been selected. The restriction-lifted weapon enhancement node 208a selected by the player includes an image in which an image icon representing a state in which the weapon 2 is being swung down and an upward arrow icon are combined. When the player selects the restriction-lifted weapon enhancement node 208a, the skill acquisition sub-screen 210 is superimposed and displayed on the weapon information display section 205.

The processing by which the player causes the character to acquire a skill through the skill acquisition sub-screen 210 is performed in a manner similar to the long pressing operation illustrated in the skill acquisition sub-screen 100 of FIG. 9. The weapon effect change unit 46 changes the game content effect when the first specific operation (for example, long pressing) is performed through the input unit 42 after the weapon enhancement node 208a in which the node unlocking condition is not satisfied is selected by the operation of the player, and the node unlocking condition associated with the weapon enhancement node 208a is satisfied. The skill acquired by the character is displayed differently from the weapon enhancement node 208a representing the skill that has not been acquired yet, by changing the color of the weapon enhancement node 208a illustrated in FIG. 18, or the like. Thus, the player can easily distinguish the restricted weapon enhancement node 208b from the unlocked weapon enhancement node 208a.

In the game system according to the second embodiment, the processing illustrated in the flowcharts of FIG. 13 to FIG. 15 according to the first embodiment is also performed. However, in the game system according to the second embodiment, since no weapon enhancement node is present in the skill tree 70B, the processing step of determining whether the weapon enhancement node has been unlocked in step S16 and the processing step of outputting the message indicating that “weapon enhancement is necessary” in step S17 in the processing for unlocking nodes as illustrated in FIG. 14 are not necessary.

### Example of Processing for Weapon Enhancement Bonus

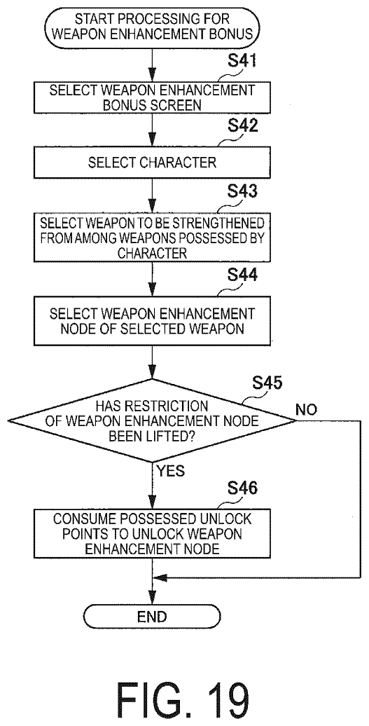

FIG. 19 is a flowchart illustrating an example of processing for a weapon enhancement bonus. The processing for the weapon enhancement bonus is processing that is performed through the weapon enhancement bonus screen 200 illustrated in FIG. 18.

First, the player operates the controller 60 to select the weapon enhancement bonus screen 200 (S41). Next, the player selects a character from the character selection section 204 (S42).

Next, the player selects a weapon to be strengthened from among the weapons possessed by the character based on the weapon information displayed in the weapon information display section 205 (S43). Next, the player selects a weapon enhancement node of the selected weapon (S44).

Next, the weapon effect change unit 46 determines whether the restriction of the weapon enhancement node has been lifted (S45). In a case where the restriction of the weapon enhancement node has not been lifted (NO in S45), the weapon effect change unit 46 ends the present processing. Thus, the player performs processing for weapon enhancement as illustrated in FIG. 15, which will be described below, and performs an operation of lifting the restriction of the weapon enhancement node.

On the other hand, in a case where the restriction of the weapon enhancement node has been lifted (YES in S45), the weapon effect change unit 46 consumes the possessed unlock points to unlock the weapon enhancement node (S46), and ends the present processing.

In the game system according to the second embodiment described above, the weapon enhancement bonus screen 200 is newly provided, thereby allowing the player to strengthen the weapon while checking the character and the weapon to be strengthened, and thus causing the character to acquire the skill. This makes it possible for the player to easily check how many weapon enhancement nodes 208a have been unlocked and which skills the character has acquired. Further, since the image of the lock is displayed in a superimposed manner on the restricted weapon enhancement node 208a, the player can easily check the restricted weapon enhancement node 208a.

Note that the restriction lifting condition may be displayed when the player selects the restricted weapon enhancement node 208b. By checking the displayed restriction lifting condition, the player can easily determine a guide for raising the weapon level or breaking the limit of the weapon level.

Further, although the weapon enhancement nodes 208a illustrated in the weapon enhancement bonus screen 200 of FIG. 18 are not in a tree shape, a plurality of weapon enhancement nodes 208a may be configured in a tree shape similar to the skill tree 70.

Note that the present invention is not limited to the above-described embodiments, and various other applications and modified examples can be made without departing from the gist of the present invention described in the claims.

For example, the above-described embodiments are intended to describe the configuration of the system in detail and specifically in order to describe the present invention in an easy-to-understand manner, but the present invention is not necessarily limited to the embodiments including all the described configurations. In addition, another configuration can be added to a part of the configuration of the present embodiment, or such a part can be deleted or replaced.

In addition, control lines and information lines that are considered to be necessary for description are illustrated, and all control lines and information lines in a product are not necessarily illustrated. It may be conceivable that almost all the components are actually connected to each other.

### Reference Signs List

1 Game server, 2 Information processing terminal, 10 Game system, 11 Processing device, 12 Storage device, 26 Input device, 27 Output device, 32 Game processing unit, 42 Input unit, 43 Input reception unit, 44 Path selection unit, 45 Character effect change unit, 46 Weapon effect change unit, 47 Drawing unit, 48 Image output unit, 49 Output unit, 60 Controller, 70 Skill tree, 90 Skill setting screen, 95 Skill tree display section, 100 Skill acquisition sub-screen, 110 Multi-skill acquisition sub-screen, 140 Weapon enhancement screen, 150 Weapon enhancement sub-screen, 160 Limit break sub-screen, 200 Weapon enhancement bonus screen, 208a Weapon enhancement node, 208b Restricted weapon enhancement node

1. A program for providing a game in which a change factor unlocking condition is determined for an individual change factor and a change element including a plurality of the change factors is provided for an individual piece of game content, the program being configured to cause a computer to execute:
changing a game content effect of the individual piece of game content by satisfying the change factor unlocking condition;
changing a game element effect of a game element by satisfying a game element unlocking condition determined for each of a plurality of the game elements associated with the individual piece of game content; and
changing the game content effect by satisfying the change factor unlocking condition associated with a specific change factor after the game element effect of the game element associated with the specific change factor in which the game content effect is changed by the change of the game element effect reaches a specified value.

2. The program according to claim 1, wherein
each of the plurality of game elements is associated with the corresponding piece of the game content by acquisition of the game element by the corresponding piece of the game content, and
the game element unlocking condition is set differently for each of the plurality of game elements.

3. The program according to claim 2, wherein the change factor unlocking condition is satisfied by consuming a predetermined number of pieces of unlock content acquired in the game,
the game element unlocking condition is satisfied by consuming a predetermined number of pieces of unlock content acquired in the game after the change factor becomes selectable by lifting restriction defined in a restriction lifting condition, and
the restriction lifting condition includes any one selected from the group consisting of conditions that the game element effect reaches the specified value, the game element is acquired, and a limit of the game element effect is broken.

4. The program according to claim 3, wherein
the specified value is a level value of each of the plurality of game elements or a limit level value of each of the plurality of game elements.

5. The program according to claim 4, wherein
the change element is configured by combining the plurality of the change factors, and
the program comprises selecting the change factor not satisfying the change factor unlocking condition from among the plurality of the change factors included in the change element.

6. The program according to claim 5, wherein
a first screen on which the change element is drawn and a second screen on which a second change element for which the game element unlocking condition is determined is drawn are configured to be switchable.

7. The program according to claim 5, wherein
at least one selected from the group consisting of the change factor unlocking condition and the game element unlocking condition is determined for the specific change factor.

8. The program according to claim 6, further comprising:
selecting the change factor not satisfying the change factor unlocking condition along a path of the change factor connected to a start point, with the start point being the change factor satisfying the change factor unlocking condition.

9. The program according to claim 8, further comprising:
in a state where one or more of the change factors each of which does not satisfy the change factor unlocking condition are present on a path including the change factor satisfying the change factor unlocking condition as a start point and the change factor not satisfying the change factor unlocking condition as an end point, when the change factor unlocking condition of each of the one or more of the change factors present on the path and the change factor serving as the end point is satisfied, collectively changing the game content effect of each of the one or more of the change factors present on the path and the game content effect of the change factor serving as the end point.

10. An effect change method for a game in which a change factor unlocking condition is determined for an individual change factor and a change element including a plurality of the change factors is provided for an individual piece of game content, the effect change method comprising:
changing a game content effect of the individual piece of game content by satisfying the change factor unlocking condition;
changing a game element effect of a game element by satisfying a game element unlocking condition determined for each of a plurality of the game elements associated with the individual piece of game content; and
changing the game content effect by satisfying the change factor unlocking condition associated with a specific change factor after the game element effect of the game element associated with the specific change factor in which the game content effect is changed by the change of the game element effect reaches a specified value.

11. A game apparatus configured to provide a game in which a change factor unlocking condition is determined for an individual change factor and a change element including a plurality of the change factors is provided for an individual piece of game content, the game apparatus comprising:
a game content effect change unit configured to change a game content effect of the individual piece of game content by satisfying the change factor unlocking condition; and
a game element effect change unit configured to change a game element effect of a game element by satisfying a game element unlocking condition determined for each of a plurality of the game elements associated with the individual piece of game content, wherein
the game content effect change unit changes the game content effect by satisfying the change factor unlocking condition associated with a specific change factor after the game element effect of the game element associated with the specific change factor in which the game content effect is changed by the change of the game element effect reaches a specified value.
